(19) United States
(12) Patent Application Publication
(10) Pub. No.: US 2024/0402895 A1
(43) Pub. Date: Dec. 5, 2024

(54) MANAGING USER INTERFACES FOR CONTROLLING EXTERNAL DEVICES

(71) Applicant: Apple Inc., Cupertino, CA (US)

(72) Inventors: Erik R. KLIMCZAK, Mill Valley, CA (US); Vincenzo O. GIULIANI, Thousand Oaks, CA (US); James F. FELKINS, San Francisco, CA (US)

(21) Appl. No.: 18/637,036

(22) Filed: Apr. 16, 2024

Related U.S. Application Data
(60) Provisional application No. 63/470,974, filed on Jun. 4, 2023.

(51) Int. Cl. G06F 3/04847; G06F 3/01

(52) U.S. Cl. CPC G06F 3/04847; G06F 3/016; G06F 2203/04803

(57) ABSTRACT

The present disclosure generally relates to managing one or more external devices. In some embodiments, one or more techniques are described, such as managing a control for operating various modes of an external device and managing a control indicating work performed by an external device.

### CROSS-REFERENCE TO RELATED APPLICATIONS

The present application claims priority to U.S. Provisional Patent Application Ser. No. 63/470,974, entitled “MANAGING USER INTERFACES FOR CONTROLLING EXTERNAL DEVICES” filed Jun. 4, 2023, which is hereby incorporated by reference in its entirety for all purposes.

### FIELD

The present disclosure relates generally to computer user interfaces, and more specifically to techniques for controlling external devices.

### BACKGROUND

As external devices become more prevalent, the number of devices that are being used are increasing. Using current techniques managing and controlling external devices is a cumbersome and tedious task. Accordingly, there is a need to improve techniques for managing and controlling external devices.

### SUMMARY

Some techniques for controlling external devices using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling external devices. Such methods and interfaces optionally complement or replace other methods for controlling external devices. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display generation component and one or more input devices is described. In some embodiments, the method comprises: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a non-transitory computer-readable storage medium storing one or more programs configured to be executed by one or more processors of a computer system that is in communication with a display generation component and one or more input devices is described. In some embodiments, the one or more programs includes instructions for: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a transitory computer-readable storage medium storing one or more programs configured to be executed by one or more processors of a computer system that is in communication with a display generation component and one or more input devices is described. In some embodiments, the one or more programs includes instructions for: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a computer system that is in communication with a display generation component and one or more input devices is described. In some embodiments, the computer system that is in communication with a display generation component and one or more input devices comprises one or more processors and memory storing one or more programs configured to be executed by the one or more processors. In some embodiments, the one or more programs includes instructions for: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a computer system that is in communication with a display generation component and one or more input devices is described. In some embodiments, the computer system that is in communication with a display generation component and one or more input devices comprises means for performing each of the following steps: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: displaying, via the display generation component, a first user interface that includes: a representation of a setting for an external device; and a first control; while displaying the first user interface that includes the representation of the setting that corresponds to the external device and the first control, detecting, via the one or more input devices, an input directed to the first control; in response to detecting the input directed to the first control, displaying, via the display generation component, a second user interface that includes: a second control for saving an appearance of one or more appearance attributes of output for the setting; and a set of one or more controls for adjusting the one or more appearance attributes of output for the setting; while displaying the second user interface that includes the second control and the set of one or more controls, detecting, via the one or more input devices, a first set of one or more inputs directed to the set of one or more controls; in response to detecting the first set of one or more inputs directed to the set of one or more controls, changing one or more representations of the one or more appearance attributes of output for the setting; after the one or more representations of the one or more appearance attributes of output for the setting are changed and while displaying the second control, detecting, via the one or more input devices, a first input directed to the second control; and in response to detecting the first input directed to the second control, saving an appearance of output for a respective setting that includes the changed one or more appearance attributes.

In some embodiments, a method that is performed at a computer system that is in communication with a display generation component is described. In some embodiments, the method comprises: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a non-transitory computer-readable storage medium storing one or more programs configured to be executed by one or more processors of a computer system that is in communication with a display generation component is described. In some embodiments, the one or more programs includes instructions for: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a transitory computer-readable storage medium storing one or more programs configured to be executed by one or more processors of a computer system that is in communication with a display generation component is described. In some embodiments, the one or more programs includes instructions for: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a computer system that is in communication with a display generation component is described. In some embodiments, the computer system that is in communication with a display generation component comprises one or more processors and memory storing one or more programs configured to be executed by the one or more processors. In some embodiments, the one or more programs includes instructions for: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a computer system that is in communication with a display generation component is described. In some embodiments, the computer system that is in communication with a display generation component comprises means for performing each of the following steps: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a computer program product is described. In some embodiments, the computer program product comprises one or more programs configured to be executed by one or more processors of a computer system that is in communication with a display generation component. In some embodiments, the one or more programs include instructions for: receiving a request; and in response to receiving the request, displaying, via the display generation component, a user interface that includes: an indication of a current selected value for a setting; and a representation of a control for the setting, wherein: in accordance with a determination that the computer system is operating in a first mode for the first setting while the indication of the current selected value for the setting is displayed at a first position relative to the representation of the control, displaying, via the display generation component, a first section of the representation of the control and a second section of the representation of the control for the setting with a first gradient, wherein the second section of the control is closer to the first position than the first section of the control, and wherein display of the first gradient expands across the first section of the representation of the control and the second representation of the control; and in accordance with a determination that the computer system is operating in a second mode, different from the first mode, for the first setting while the indication of the current selected value for the setting is displayed at the first position relative to the representation of the control, displaying, via the display generation component, the first section of the representation of the control with the first gradient while displaying, via the display generation component, the second section of the representation of the control with a second gradient different from the first gradient.

In some embodiments, a method that is performed at a computer system that is in communication with a display generation component and one or more input devices is described. In some embodiments, the method comprises: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

In some embodiments, a non-transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

In some embodiments, a transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

In some embodiments, a computer system that is in communication with a display generation component and one or more input devices is described. In some embodiments, the computer system that is in communication with a display generation component and one or more input devices comprises one or more processors and memory storing one or more programs configured to be executed by the one or more processors. In some embodiments, the one or more programs includes instructions for: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

In some embodiments, a computer system that is in communication with a display generation component and one or more input devices is described. In some embodiments, the computer system that is in communication with a display generation component and one or more input devices comprises means for performing each of the following steps: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: displaying, via the display generation component, a user interface that includes: an indication of a current selected environmental value for a setting of a device; an indication of a current detected environmental value for the setting of the device; and a first set of one or more indications at a first set of one or more positions between the indication of the current selected environmental value for the setting and the indication of the current detected environmental value for the setting of the device; while displaying the first set of one or more indications at the first set of one or more positions, detecting, via the one or more input devices, an input corresponding to a request to change the current selected environmental value for the setting; and in response to detecting the input corresponding to the request to change the current selected environmental value for the setting: moving display of the indication of the current selected environmental value from a first position to a second position; and displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling external devices, thereby increasing the effectiveness, efficiency, and user satisfaction with such devices. Such methods and interfaces may complement or replace other methods for controlling external devices.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an electronic device in accordance with some embodiments.

FIG. 5J is a block diagram illustrating an electronic device in accordance with some embodiments.

FIGS. 6A-6U illustrate exemplary user interfaces for managing an appearance of output for an external device in accordance with some embodiments.

FIG. 7 is a flow diagram illustrating a method for managing an appearance of output for an external device.

FIGS. 8A-8J illustrate exemplary user interfaces for managing a control for an external device in accordance with some embodiments.

FIG. 9 is a flow diagram illustrating a method for managing a control for operating various modes of an external device in accordance with some examples.

FIG. 10 is a flow diagram illustrating a method for managing a control indicating work performed by an external device in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing multiple external devices. For example, computer systems can allow a user to manage multiple external devices by allowing users to customize an appearance of output for multiple external devices and/or manage the operation of multiple external devices. Such techniques can reduce the cognitive burden on a user who manage multiple external devices conveniently from one computer system, thereby enhancing productivity. Further, such techniques can reduce processor and battery power otherwise wasted on redundant user inputs.

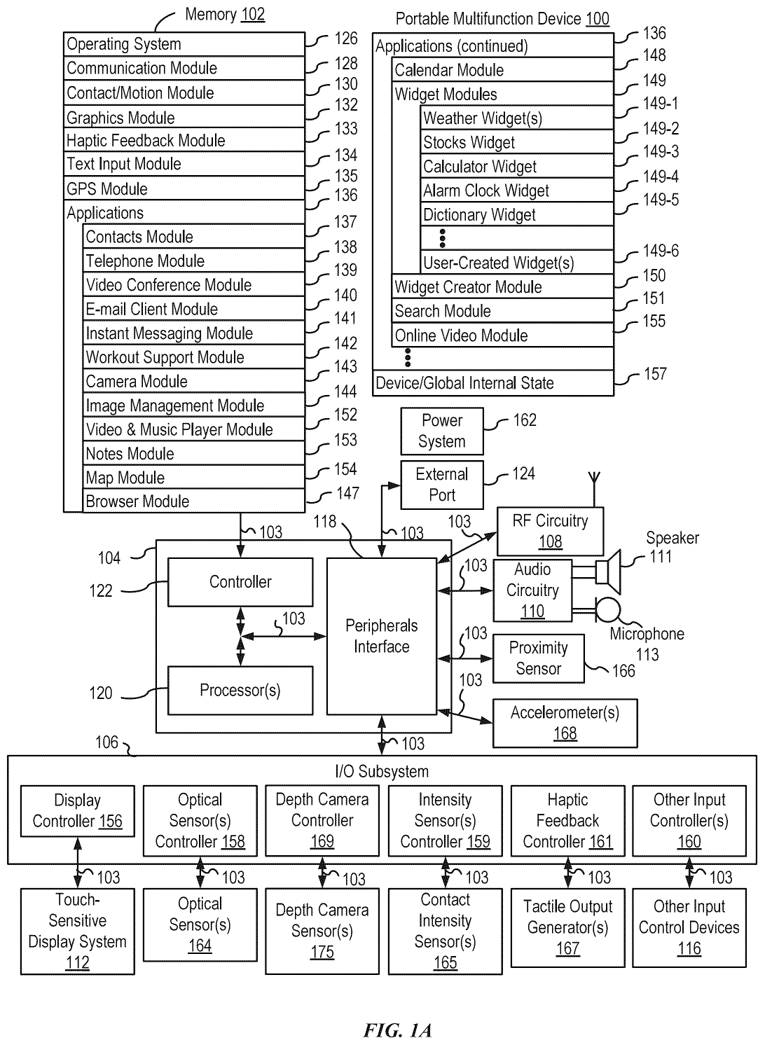

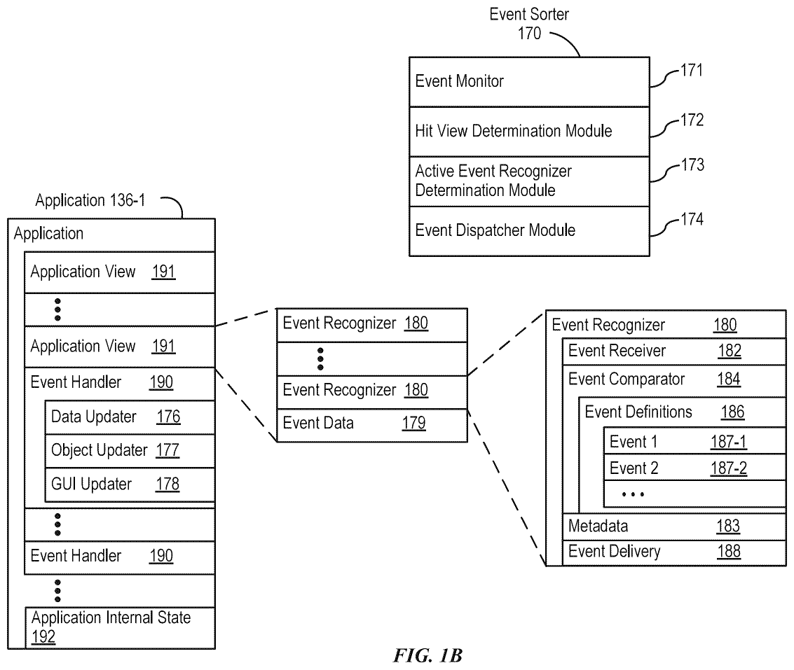

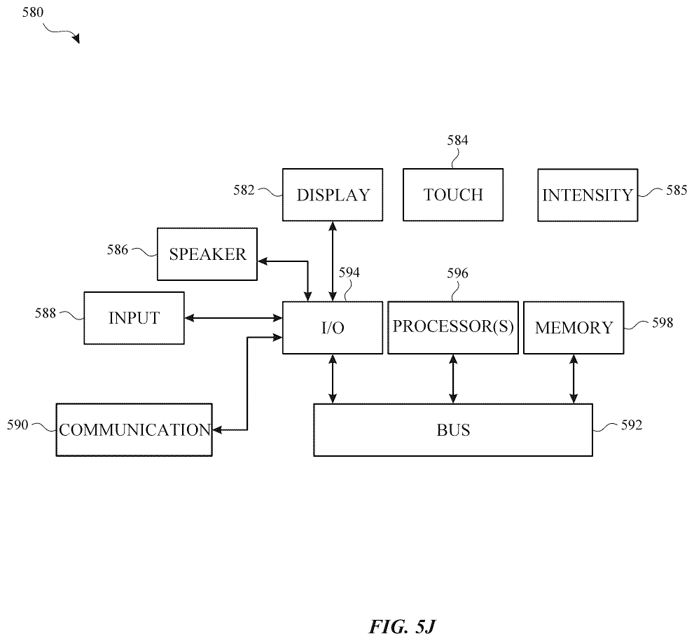

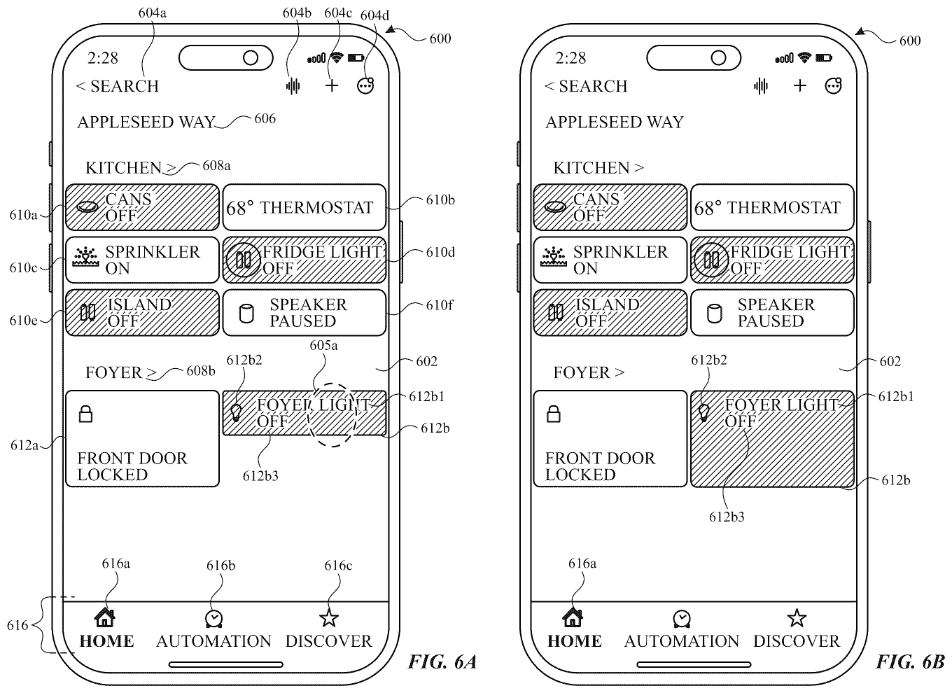

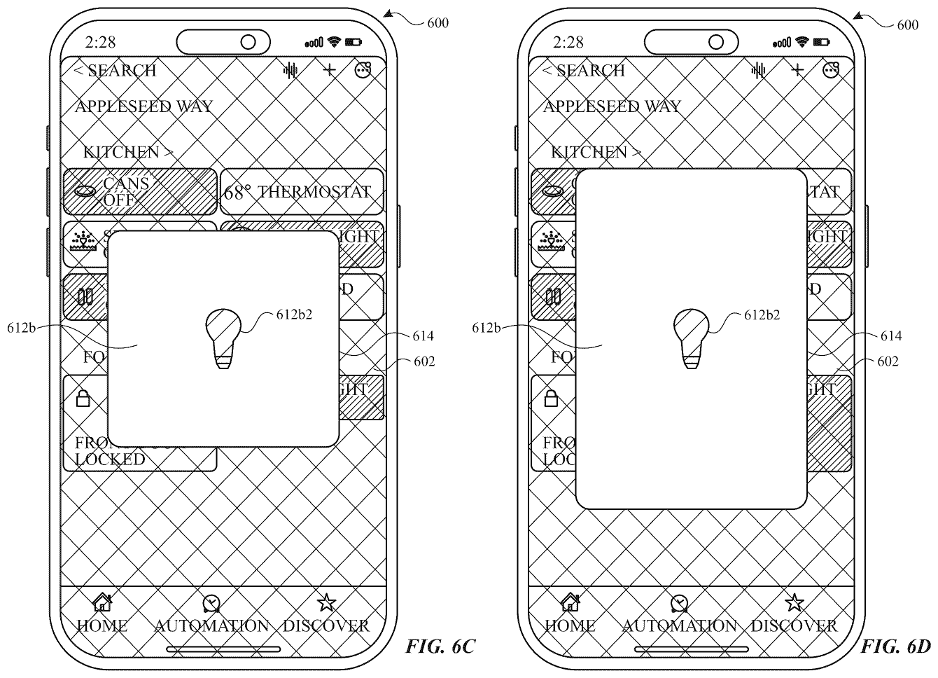

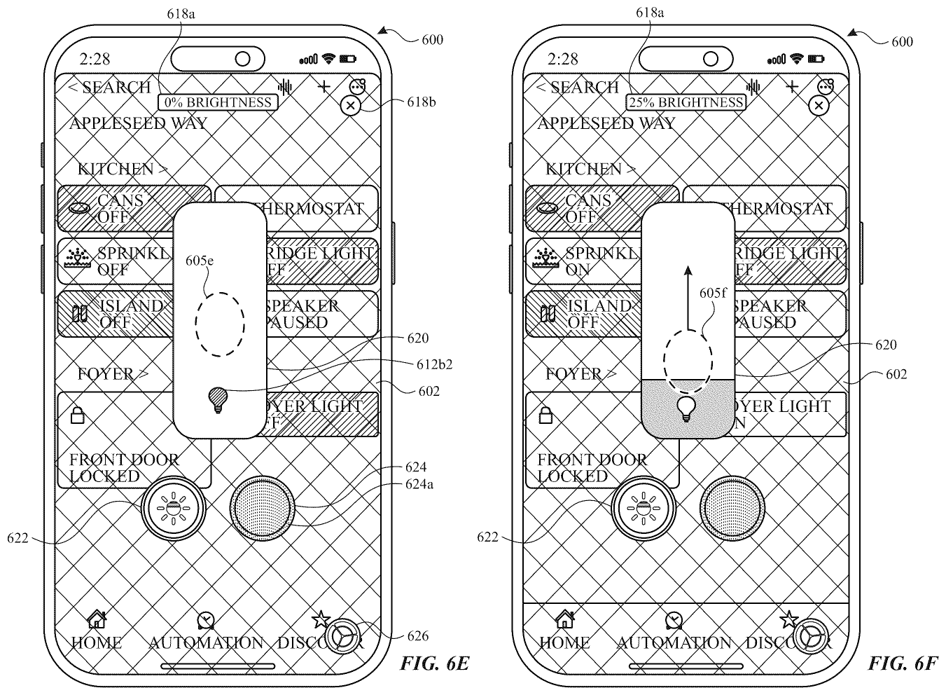

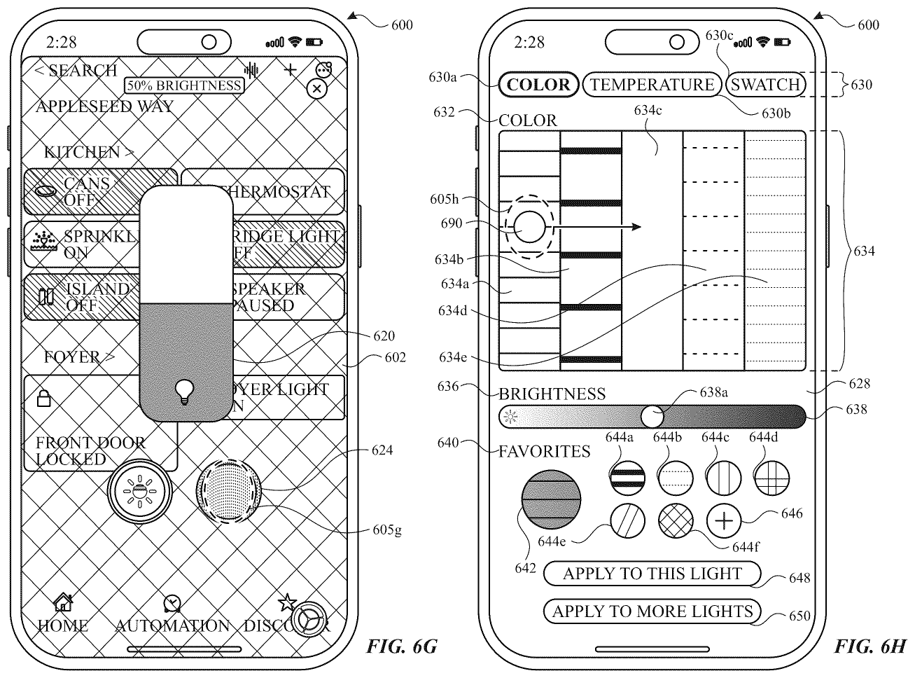

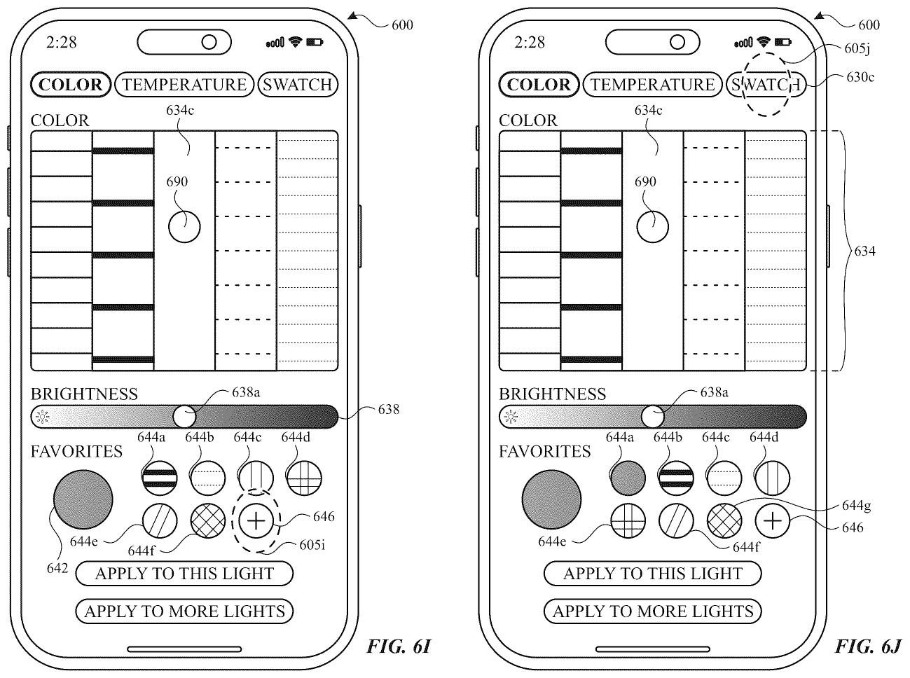

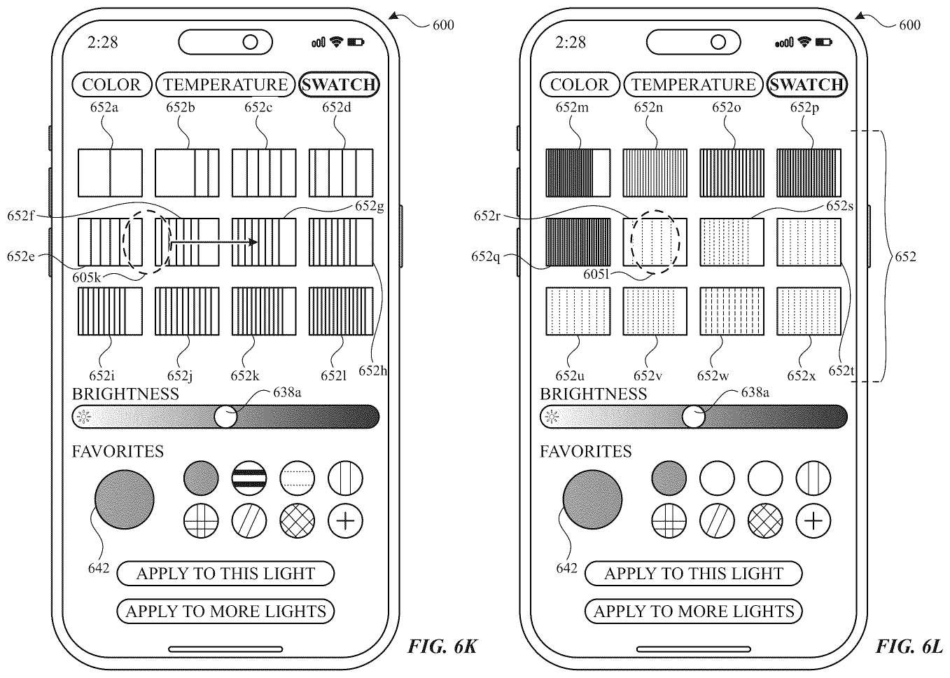

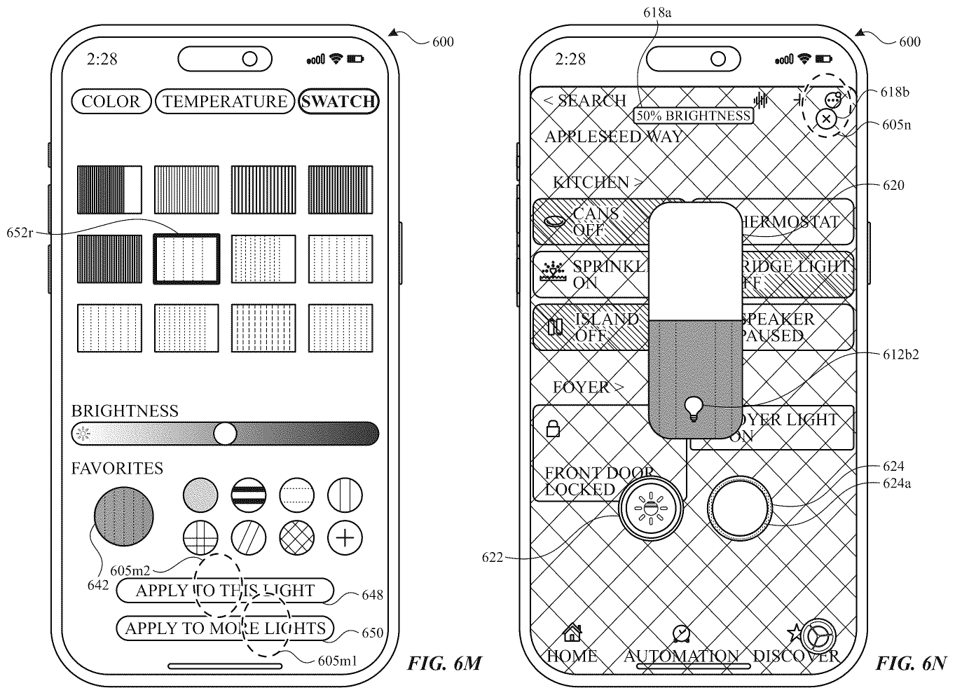

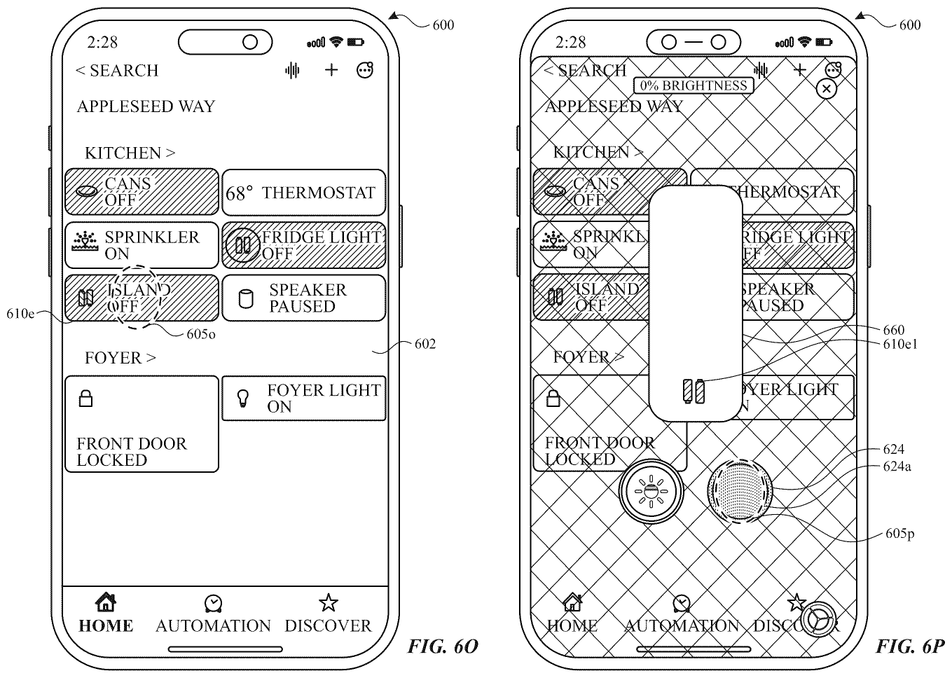

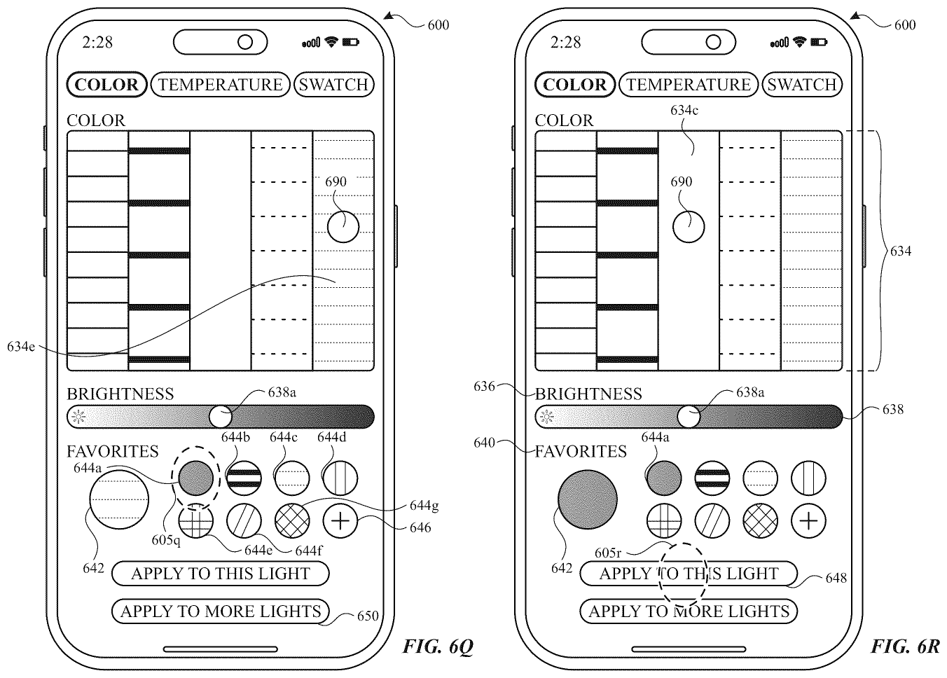

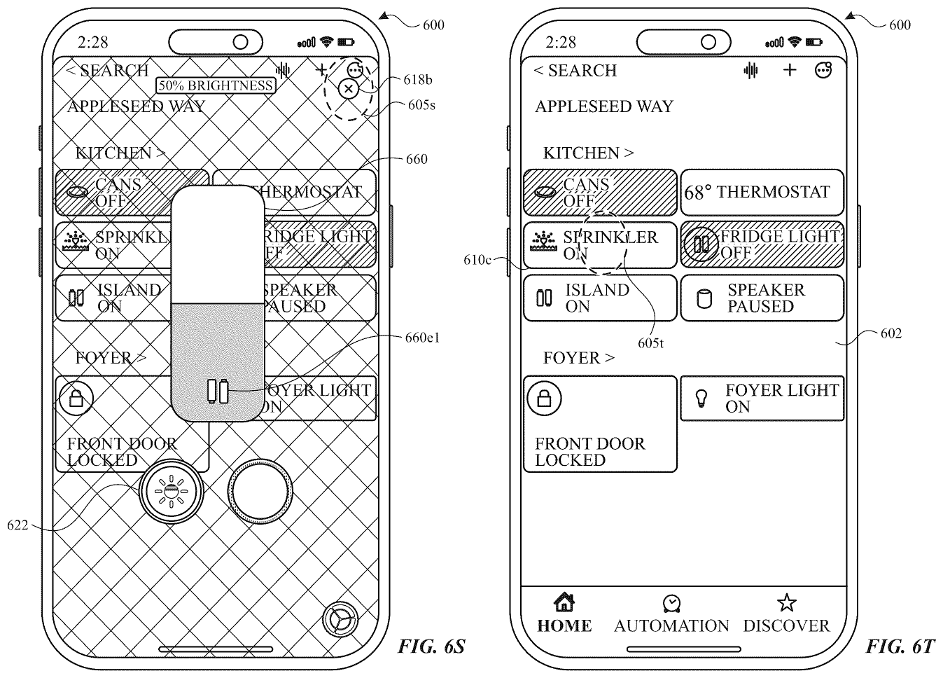

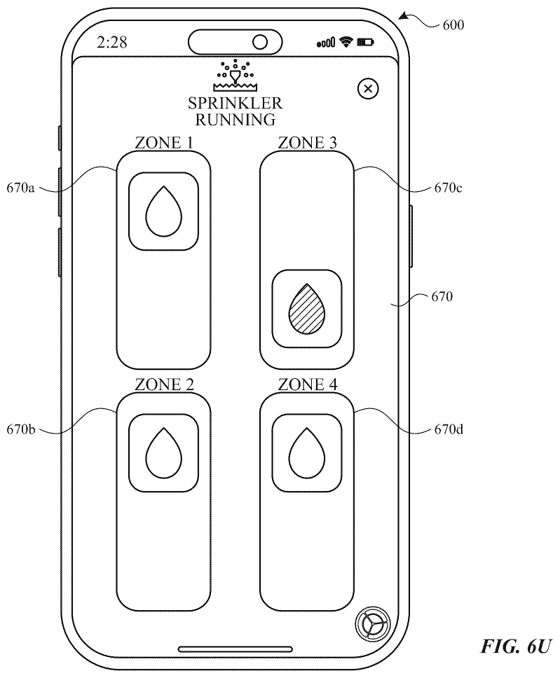

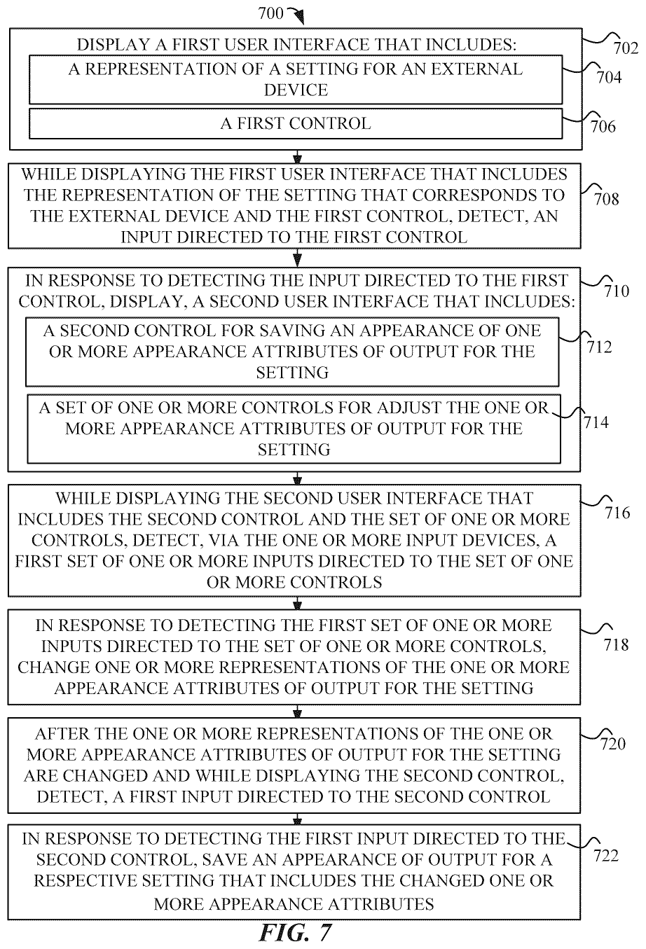

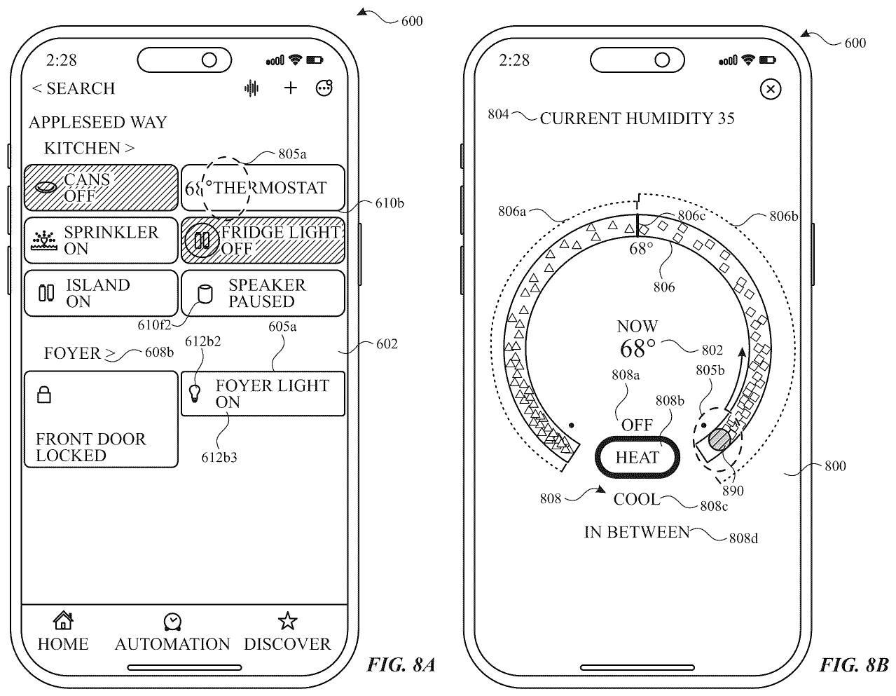

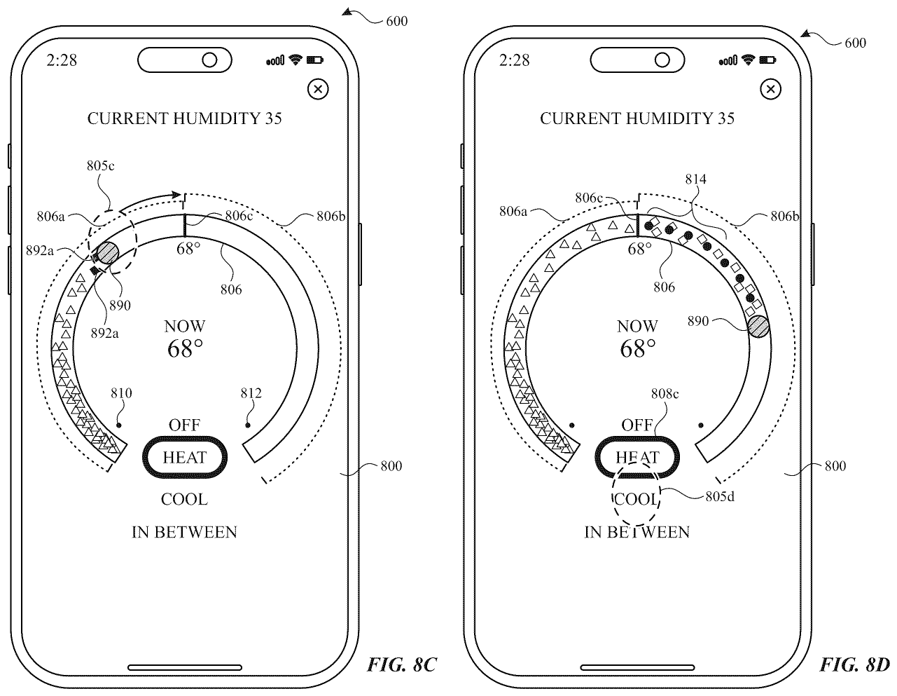

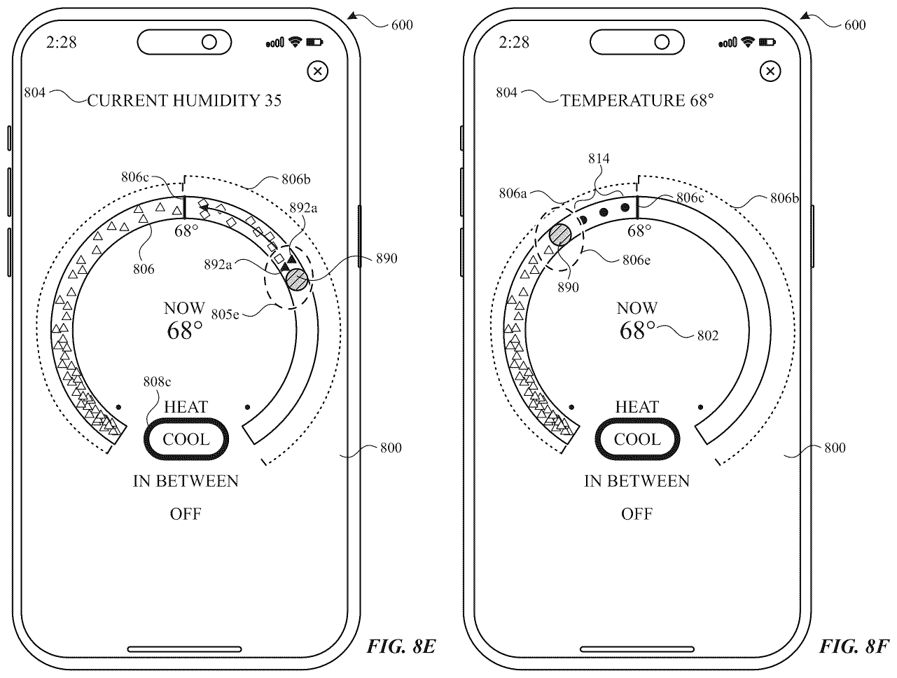

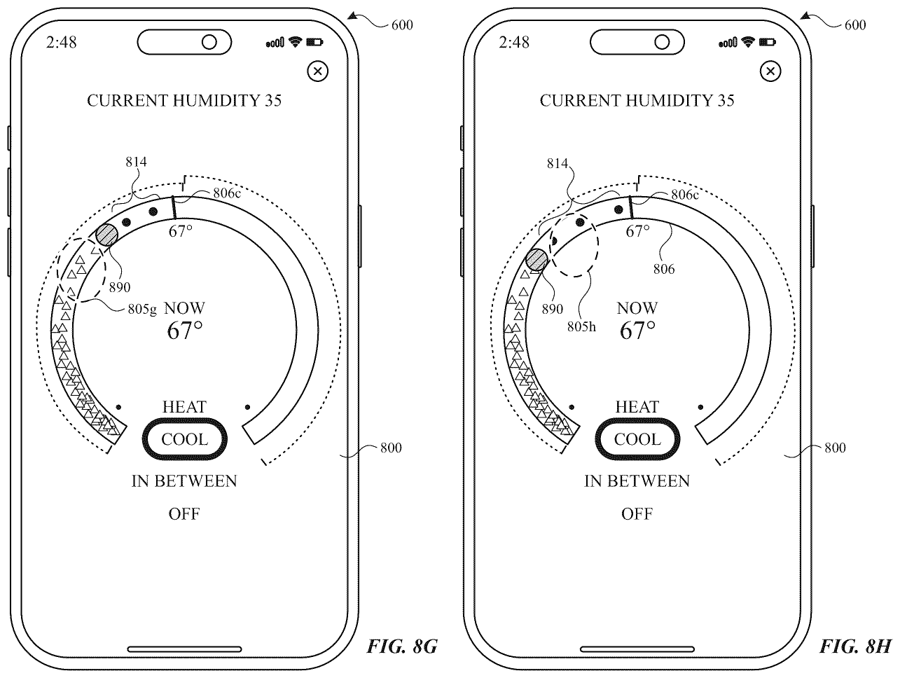

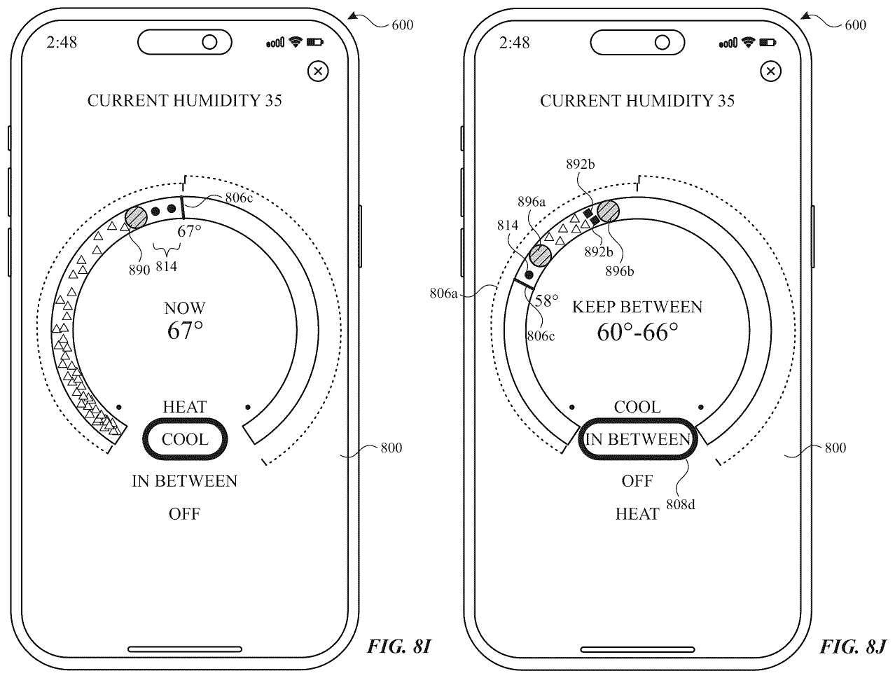

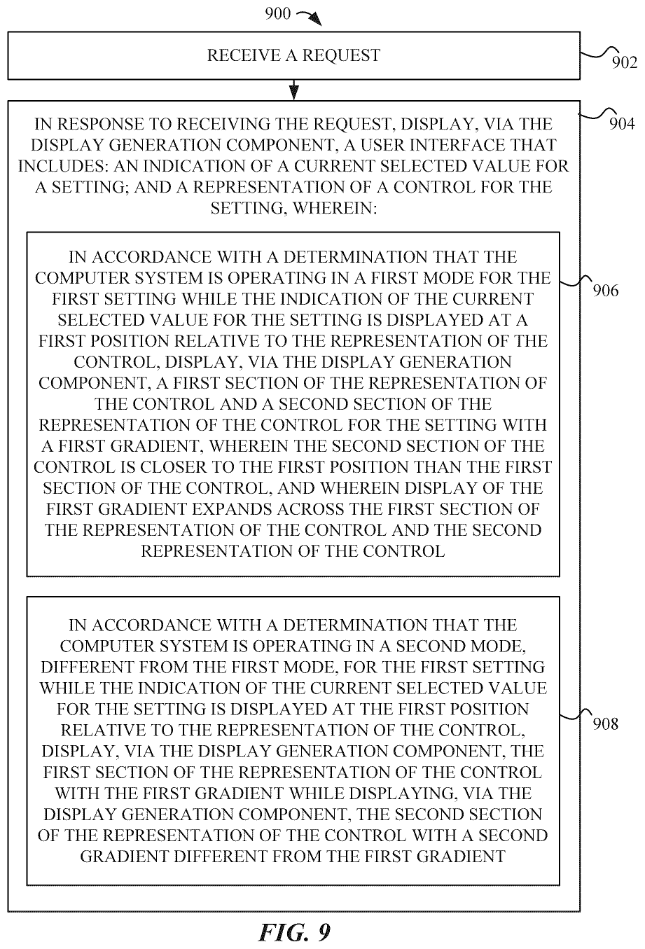

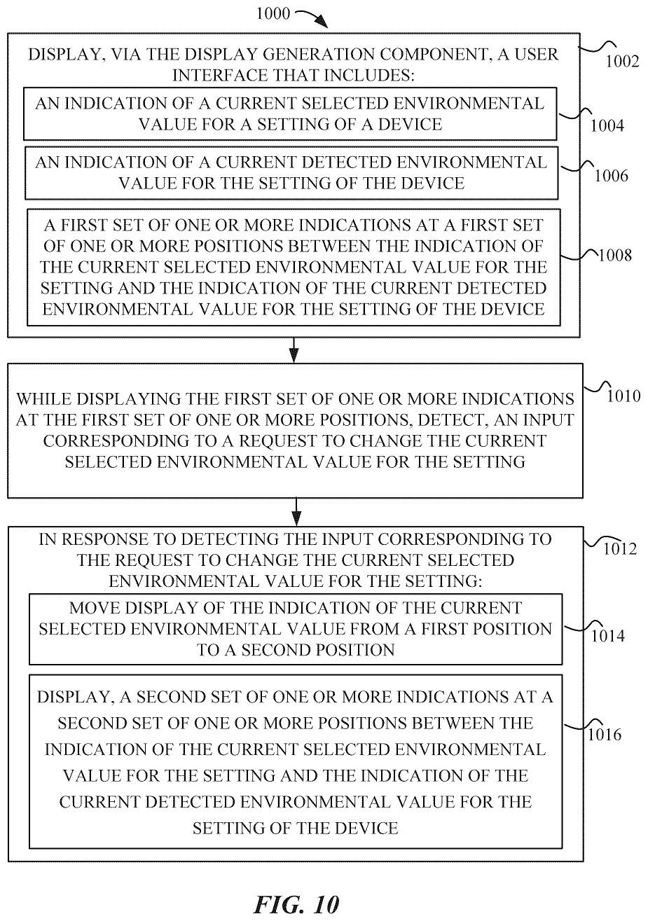

Below, FIGS. 1A-1B, 2, 3, 4A-4B, and 5A-5J provide a description of exemplary devices for performing the techniques for controlling external devices. FIGS. 6A-6U illustrate exemplary user interfaces for managing an appearance of output for an external device in accordance with some examples. FIG. 7 is a flow diagram illustrating methods of managing an appearance of output for an external device in accordance with some examples. The user interfaces in FIGS. 6A-6U are used to illustrate the processes described below, including the processes in FIG. 7. FIGS. 8A-8J illustrate exemplary user interfaces for managing a control for an external device in accordance with some examples. FIG. 9 is a flow diagram illustrating methods of managing a control for operating various modes of an external device in accordance with some examples. FIG. 10 is a flow diagram illustrating methods for managing a control indicating work performed by an external device in accordance with some examples. The user interfaces in FIGS. 8A-8J are used to illustrate the processes described below, including the processes in FIGS. 9 and 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random-access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

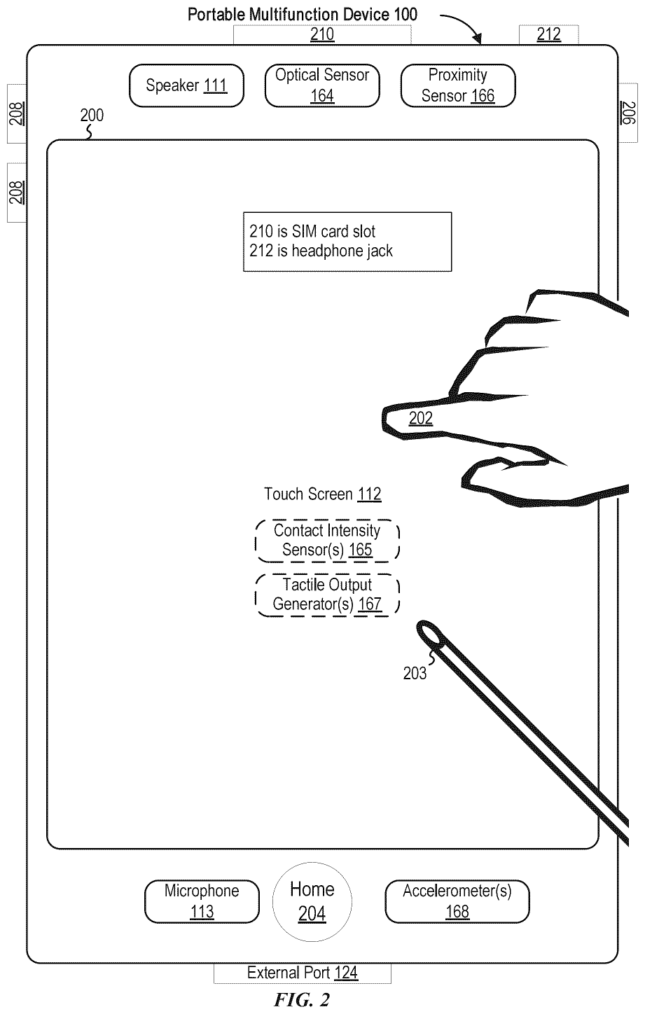

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

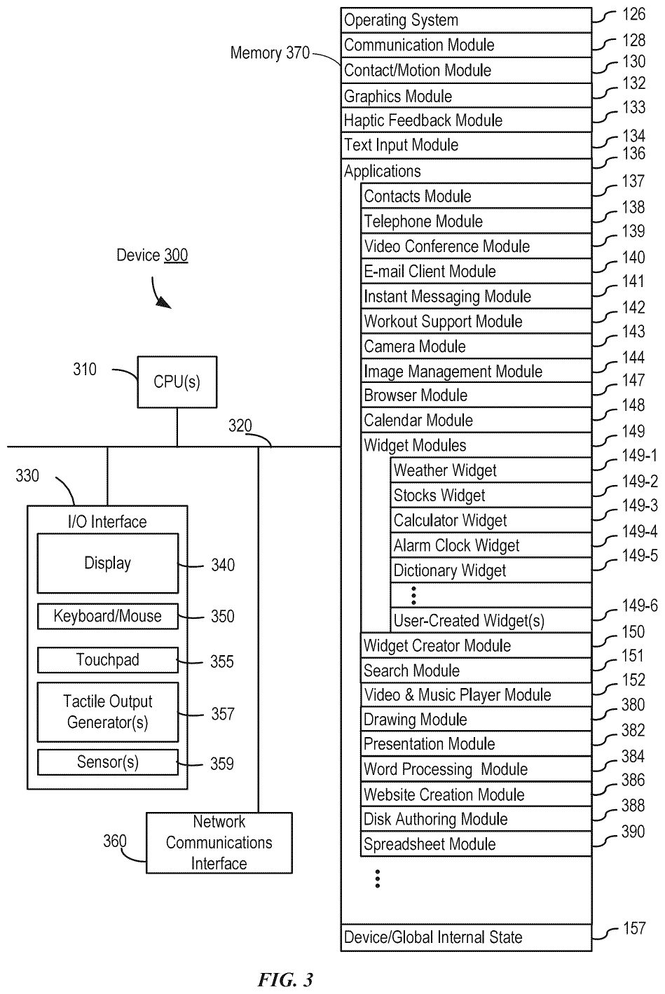

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds is determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137 or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random-access memory, such as DRAM, SRAM, DDR RAM, or other random-access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

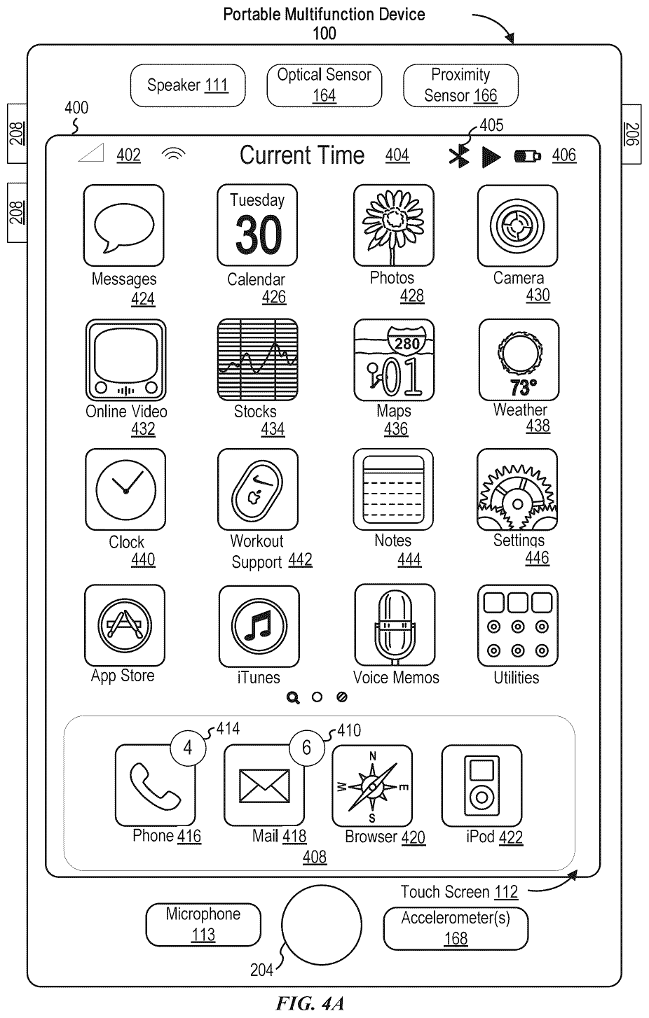

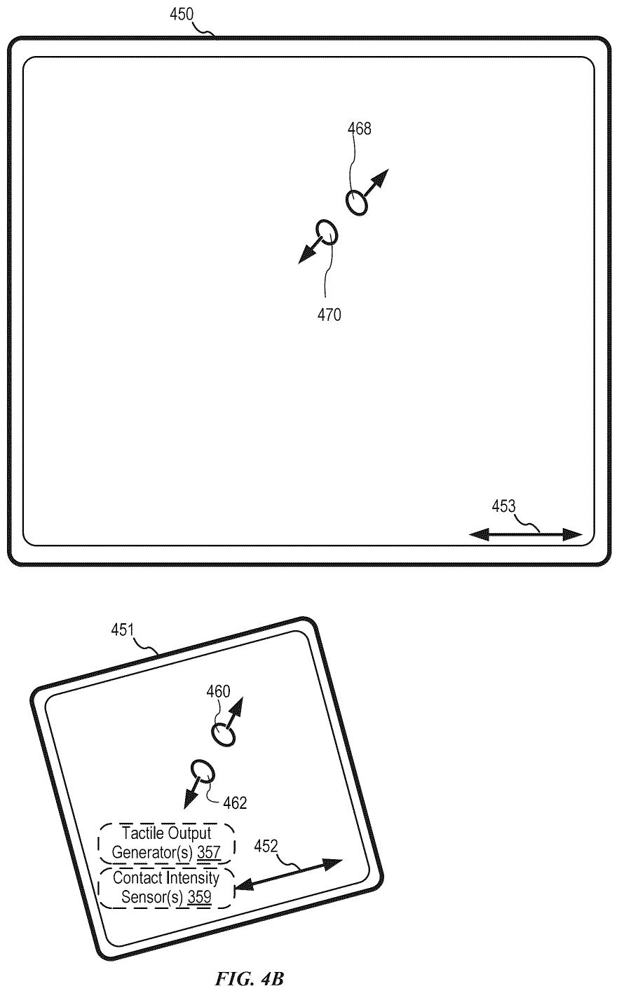

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

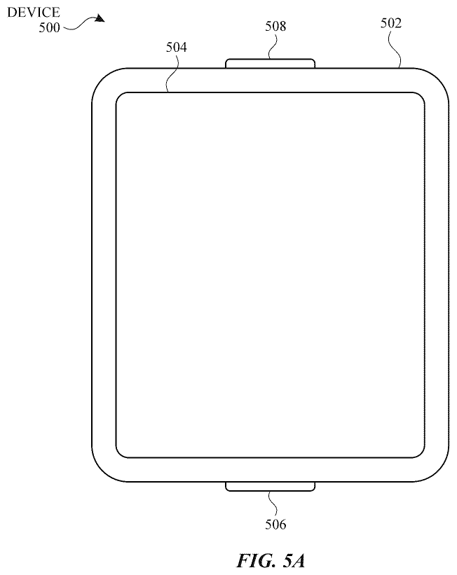

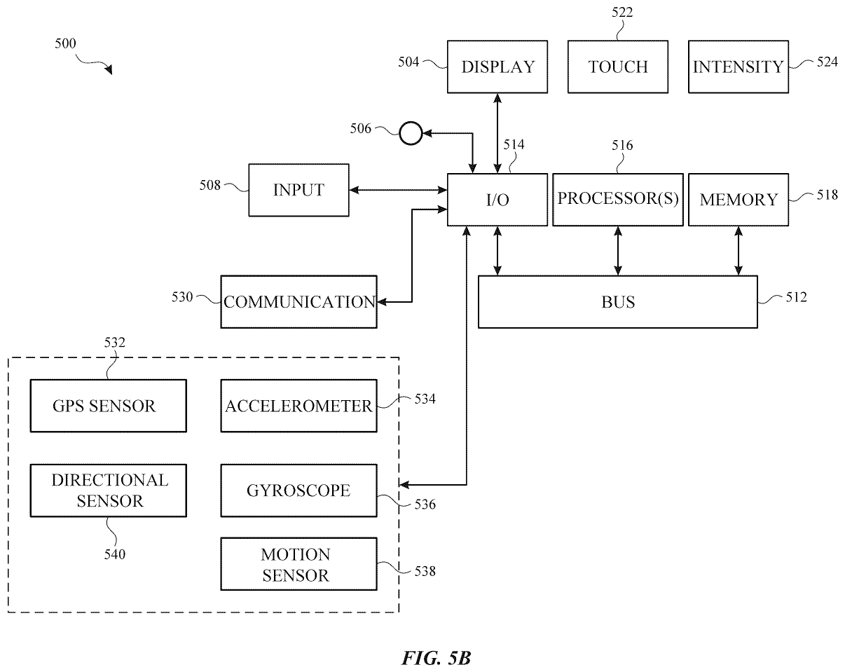

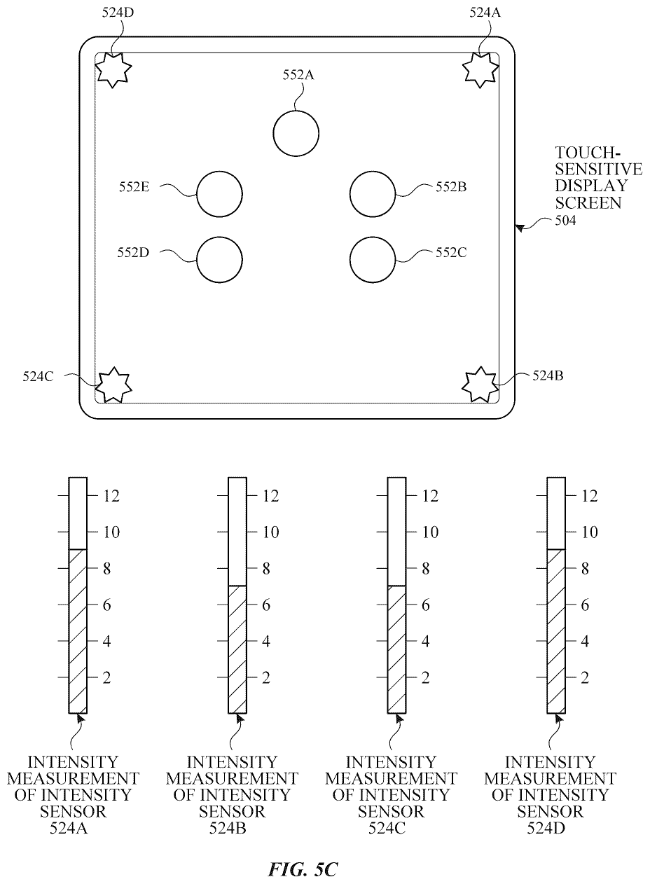

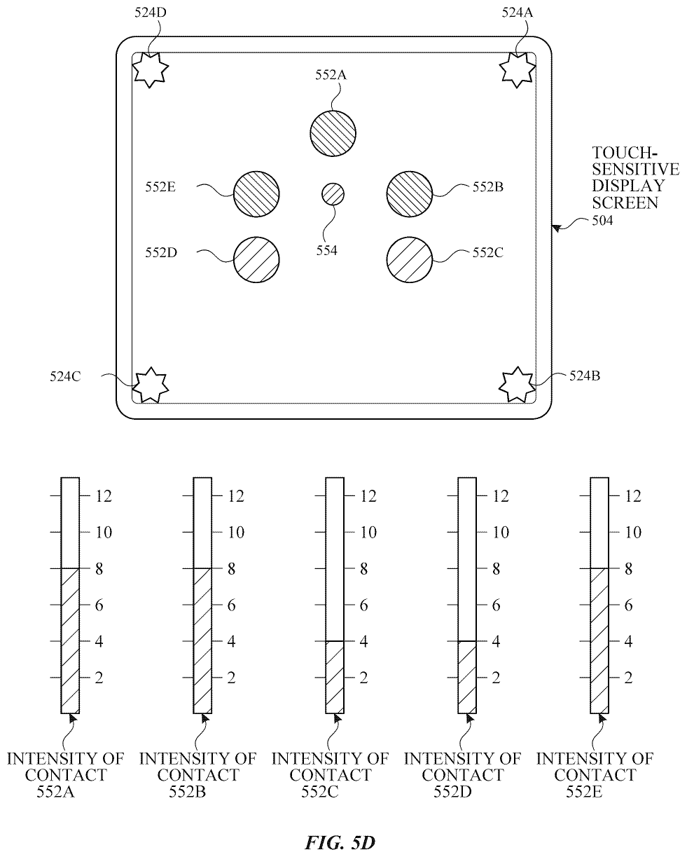

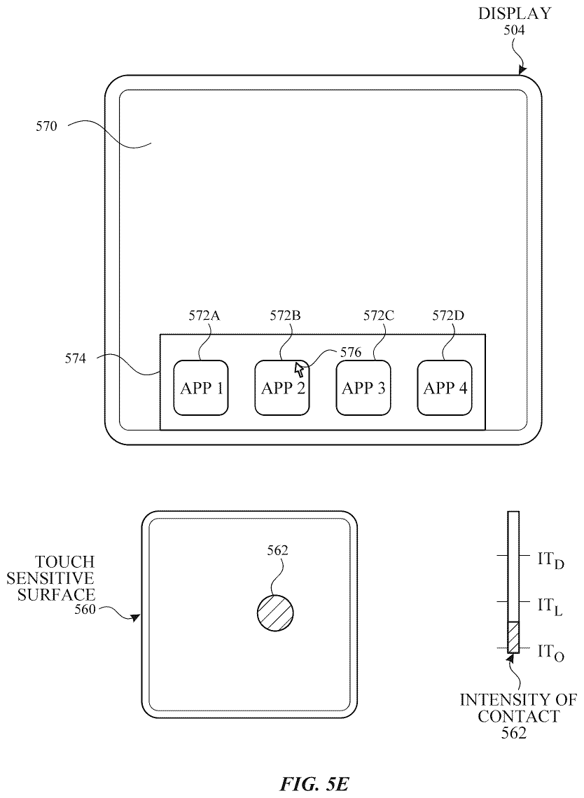

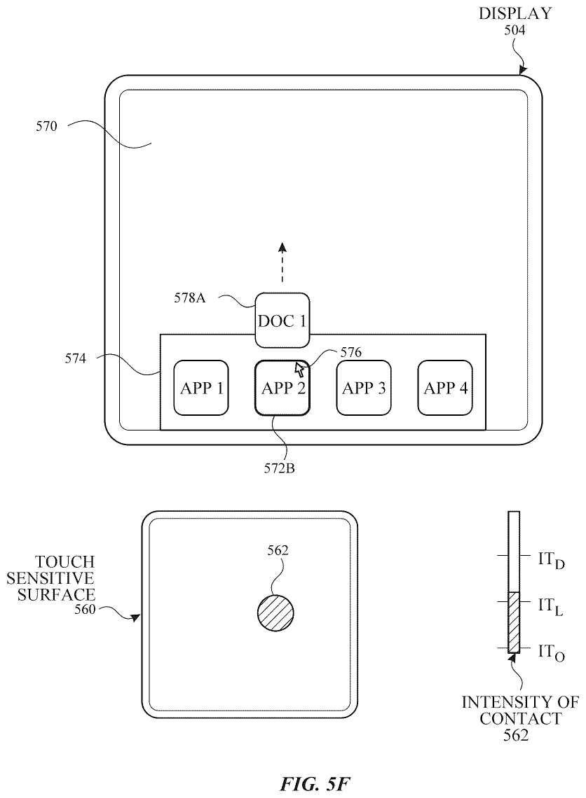

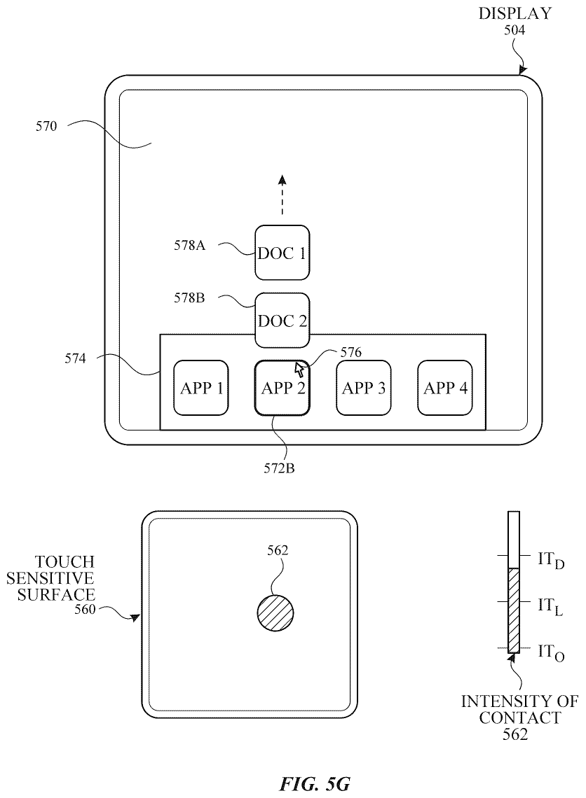

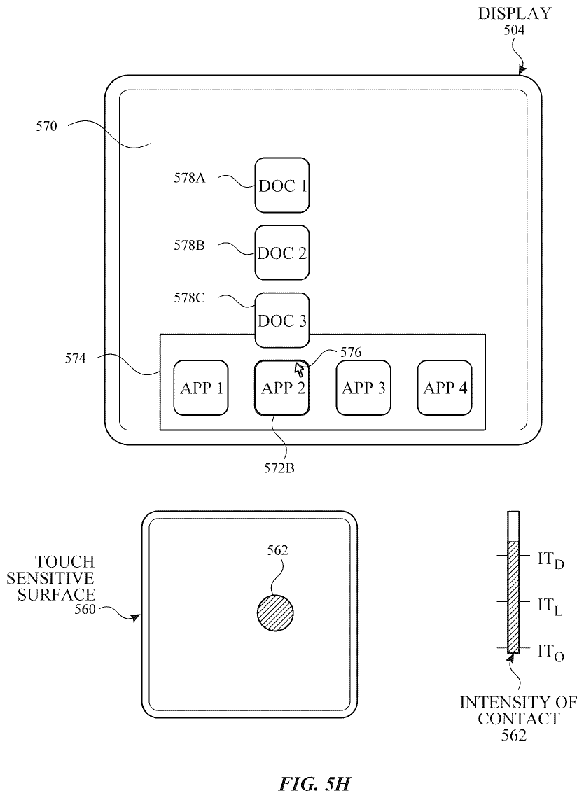

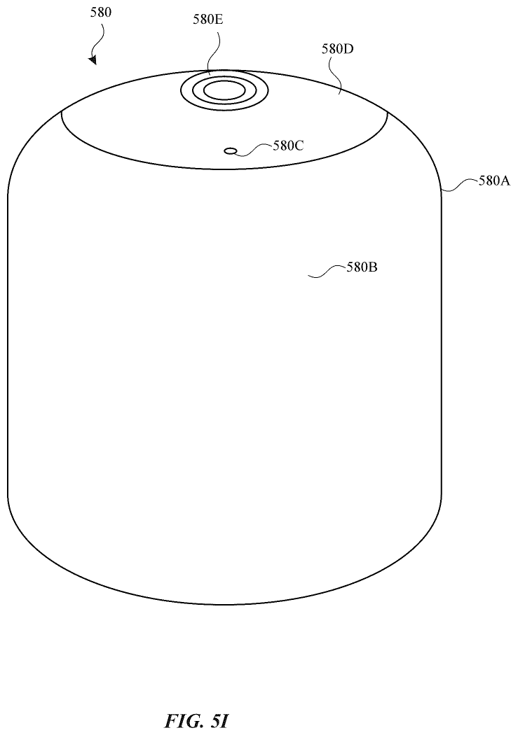

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some embodiments.

Input mechanism 508 is, optionally, a microphone, in some embodiments. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 600, 900, and 1000 (FIGS. 6, 9, and 10). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIG. 5I illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some embodiments, the one or more displays are comprised of one or more of another type of light-emitting elements.

FIG. 5J depicts exemplary personal electronic device 580. In some embodiments, device 580 can include some or all of the components described with respect to FIGS. 1A, 1B, 3, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some embodiments. Input mechanism 588 is, optionally, a microphone, in some embodiments. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 600, 900, and 1000 (FIGS. 6, 9, and 10)). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. 5J but can include other or additional components in multiple configurations.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6U illustrate exemplary user interfaces for managing an appearance of output for an external device in accordance with some embodiments. The user interfaces in these figures are used to illustrate the processes described below, including the processes in FIG. 7.

FIGS. 6A-6G illustrate an exemplary scenario, where a computer system allows a user to select a control on a home user interface to display one or more controls for changing output at one or more external devices corresponding to the control. In particular, FIGS. 6A-6G illustrate an exemplary scenario, where computer system 600 expands and/or morphs a user interface that displays multiple controls for controlling one or more external devices into a user interface that includes one or more controls for controlling one (or a subset of) the external devices. A description of the home user interface is provided below for context of the one or more scenarios. Afterwards, a control on the home user interface is selected and, in response to detecting selection of the control, the computer system morphs the selected control into a control that changes one or more properties of one or more external devices that correspond to the selected control. In some embodiments, one or more other controls can be selected, and the computer system can expand and/or morph those selected controls into different controls for changing one or more properties of one or more external devices corresponding to those selected controls.

FIGS. 6A-6G illustrates computer system 600 performing many different operations, such as displaying different user interfaces and responding to different inputs. In some embodiments, computer system 600 performs one or more similar operations in response to detecting one or more inputs that are different from the one or more inputs used in the scenarios described below. In some embodiments, computer system 600 can include one or more components of devices 100, 300, and/or 500 described above. In some embodiments, computer system 600 is a phone, a watch, a tablet, a head-mounted display (HMD) device, and/or another device.

FIG. 6A illustrates computer system 600 (e.g., a smartphone) displaying home user interface 602. Home user interface 602 is a user interface that controls one or more external devices associated with Appleseed Way (e.g., as indicated by location indicator 606). Appleseed Way is representative of a home that includes multiple rooms, such as a kitchen and a foyer. At FIG. 6A, computer system 600 displays kitchen room indicator 608a to represent the external devices associated with the kitchen and foyer room indicator 608b to represent the external devices associated with the foyer. In some embodiments, Appleseed Way is associated with other rooms, such as a dining room, living room, and/or another type of room.

As illustrated in FIG. 6A, home user interface 602 includes external devices controls 610a-610f under kitchen room indicator 608a. External device controls 610a-610f are controls for a set of one or more devices associated with the kitchen. The set of one or more devices includes various lights, a thermostat, a set of sprinklers, a refrigerator, and a speaker. As illustrated in FIG. 6A, external device controls 610a-610f include cans control 610a, thermostat control 610b, sprinkler control 610c, fridge light control 610d, island light control 610e, and speaker control 610f, each of which causes computer system 600 to cause different devices to perform different operations. In addition to external devices controls 610a-610f, computer system 600 displays external devices controls 612a-612b beneath foyer room indicator 608b, each of which cause computer system 600 to cause different devices to perform different operations. Because foyer light control 612b is used herein to describe an example related to the description, more detail is provided for foyer light control 612b.

At FIG. 6A, foyer light control 612b corresponds to a light or lights associated with and/or located in the foyer. As illustrated in FIG. 6A, foyer light control 612b includes foyer light control indicator 612b1, foyer light control graphical indicator 612b2, and foyer light control status indicator 612b3. At FIG. 6A, computer system 600 indicates that the foyer light associated with the foyer location is in an off (e.g., inactive) state (e.g., indicated by front door control status indicator 612f3 “OFF” and foyer light control and foyer light control graphical indicator 612b2 being shaded displayed in FIG. 6A). In some embodiments, in response to detecting a swipe input (e.g., a swipe up, a swipe down, a swipe right, and/or a swipe left) directed to home user interface 602, computer system 600 displays additional external device controls that are not currently illustrated in FIG. 6A. In some embodiments, a color of a respective external device control (e.g., controls 610a-610f and 612a-612b) indicates a category of the respective control (e.g., blue may be used to indicates appliances while yellow may be used to indicate lights).

Other than external device controls, home user interface 602 includes one or more navigation and/or ancillary controls, such as search control 604a, intercom control 604b, add external device control 604c, menu control 604d, location indicator 606, kitchen room indicator 608a, foyer room indicator 608b, and external devices controls 610a-610f and 612a-612b. In addition, home user interface 602 includes pages control region 616, which includes home page control 616a, automation page control 616b, and discover page control 616c. Computer system 600 hides display of one or more of the one or more navigation and/or ancillary controls after a respective external device control is expanded (e.g., as described below in relation to FIGS. 6B-6E).

FIGS. 6B-6D illustrates computer system 600 expanding and/or morphing foyer light control 612b into a slider control that can be used to change a brightness value of the foyer light. In some embodiments, one or more other controls explained above in reference to FIG. 6A can be expanded and/or morphed to display one or more other different controls. In some embodiments, computer system 600 displays the morphed and/or expanded control with one or more of the same visual characteristics (e.g., the color and/or a visual property indicating the type of external device and/or the state of the external device) as the original control (e.g., the control that was originally selected). In some embodiments, one or more controls described above in FIG. 6A are not expanded and/or morphed into a different control (e.g., using an animation similar to the one described in FIGS. 6B-6D). At FIG. 6A, computer system 600 detects tap input 605a directed to foyer light control 612b. In some embodiments, tap input 605a (and/or a different input described herein) is another input, such as a mouse click, an air tap input, and/or a touch input.

As illustrated in FIG. 6B, in response to detecting tap input 605a, computer system 600 enlarges foyer light control 612b in FIG. 6B from the size of foyer light control 612b in FIG. 6A. As illustrated in FIG. 6B, computer system 600 enlarges and/or expands foyer light control 612b from the left corner of foyer light control 612b of FIG. 6A, such that the centroid of foyer light control 612b of FIG. 6B shifts towards the centroid of home user interface 602. In some embodiments, computer system 600 enlarges foyer light control 612b from a different set of corners and/or sides than the left corner of foyer light control 612b. In some embodiments, computer system 600 does not change the position of the centroid of foyer light control 612b while enlarging foyer light control 612b.

As illustrated in FIG. 6C, at a time after computer system 600 displayed home user interface 602 of FIG. 6B, computer system 600 displays user interface element 614 overlaid onto home user interface 602 of FIG. 6C. While displaying user interface element 614 as overlaid onto home user interface 602 of FIG. 6C, computer system 600 blurs home user interface 602 (e.g., as indicated by the cross hatching illustrated in FIG. 6C). As illustrated in FIG. 6C, computer system 600 displays user interface element 614 with an enlarged version of the foyer light control as compared to foyer light control 612b of FIG. 6B. As illustrated in FIG. 6C, computer system 600 enlarges foyer light control 612b, such that foyer light control 612b is in the center of home user interface 602. As illustrated in FIG. 6C, computer system 600 dims display of displaying foyer light indicator 612b1 of FIG. 6B and foyer light status indicator 612b3 of FIG. 6B while continuing to display foyer light graphical indicator 612b2 of FIGS. 6B-6C. As illustrated in FIG. 6C, computer system 600 enlarges foyer light graphical indicator 612b2 as a part of enlarging foyer light control 612b (e.g., as compared to the size of foyer light graphical indicator 612b2 of FIG. 6B).

As illustrated in FIG. 6D, at a time after computer system 600 enlarges foyer light control 612b at FIG. 6C, computer system 600 continues to enlarge foyer light control 612b (e.g., from foyer light control 612b in FIG. 6C to the size of foyer light control 612b in FIG. 6D). As illustrated in FIG. 6D, computer system 600 enlarges foyer light graphical indicator 612b2 as a part of enlarging foyer light control 612b (e.g., as compared to the size of foyer light graphical indicator 612b2 of FIG. 6C).

FIGS. 6E-6G illustrate an exemplary scenario, where computer system 600 changes a brightness value of a light in response to detecting different types of inputs. As illustrated in FIG. 6E, computer system 600 displays brightness indicator 618a, close control 618b, adaptive light control 622, light attributes control 624, and setting control 626. As illustrated in FIG. 6E, light attributes control 624 includes region 624a positioned along the interior circumference and having a rainbow gradient color (e.g., as indicated by the different hatchings in region 624a), which light attributes control 624 also has in the region that is interior to region 624a. In some embodiments, in response to detecting an input directed to close control 618b, computer system 600 ceases displaying the foyer light slider control 620 and displays home user interface 602. For example, computer system 600 can display the opposite of the animation displayed from FIGS. 6A-6E, such as foyer light slider control 620 shrinking to become foyer light control 612b. In some embodiments, in response to detecting an input directed to adaptive light control 622, computer system 600 initiates a process for computer system 600 to automatically control a color temperature of the foyer light based on one or more conditions being met. In some embodiments, the one or more conditions includes a condition that is met based on a particular event occurring. In some embodiments, the event can be based on a time of day, the amount of light in an environment, the temperature in the environment, and/or an activity level of a person. In some embodiments, in response to detecting an input directed to setting control 626, computer system 600 displays a setting menu.

As illustrated in FIG. 6E, at a time after computer system 600 enlarges foyer light control 612b at FIG. 6D, computer system 600 displays foyer light slider control 620, which includes foyer light graphical indicator 612b2. In some embodiments, computer system 600 morphs user interface element 614 and/or foyer light control 612b of FIGS. 6B-6D into foyer light slider control 620. In some embodiments, user interface element 614 is the same as foyer light slider control 620. In some embodiments, user interface element 614 is different from foyer light slider control 620. At FIG. 6E, computer system 600 detects tap input 605e directed to foyer light slider control 620.

As illustrated in FIG. 6F, in response to detecting tap input 605e, computer system 600 changes the amount of fill represented in foyer light slider control 620 to indicate that foyer light slider control 620 has been set to a new value (e.g., 25% brightness). Notably, at FIG. 6E, foyer light slider control 620 did not include any fill because the foyer light, which corresponds to foyer light slider control 620 as discussed, was in an off state (e.g., as indicated by light foyer status indicator 612b3 of FIG. 6B). At FIG. 6F, foyer light slider control 620 includes fill, which indicates that the foyer light is in an on (e.g., active) state and not in an off state. At FIG. 6F, in response to detecting tap input 605e, computer system 600 causes the brightness of the foyer light to change with respect to the newly set value. To indicate that foyer light slider control 620 has been updated, computer system 600 also updates brightness indicator 618a and foyer light graphical indicator 612b2. As illustrated in FIG. 6F, brightness indicator 618a of FIG. 6F to indicate that the brightness value for the foyer light is now set at 25%. At FIG. 6F, computer system 600 detects upward swipe input 605f directed to foyer light slider control 620.

FIGS. 6G-6M illustrate an exemplary scenario, where an appearance of a light is saved with respect to one or more changed attributes of a light. In some embodiments, the one or more changed attributes include a brightness attribute and/or a color attribute.

As illustrated in FIG. 6G, in response to detecting upward swipe input 605f, computer system 600 displays foyer light slider control 620 with a different value. As illustrated in FIG. 6G, computer system 600 displays foyer light slider control 620 with more fill (e.g., as indicated by the grey in foyer light slider control 620 of FIG. 6G) than the amount of fill in foyer light slider control 620 of FIG. 6F. In some embodiments, when comparing FIGS. 6F-6G, computer system 600 causes the foyer light to output more brightness in FIG. 6F than in FIG. 6G because the value indicated by the fill in foyer light slider control 620 of FIG. 6G is greater than the value indicated by the fill in foyer light slider control 620 of FIG. 6F (e.g., because there is more fill in FIG. 6F as compared to FIG. 6G). At FIG. 6G, computer system 600 detects tap input 605g directed to light attributes control 624.

As illustrated in FIG. 6H, in response to detecting tap input 605g, computer system 600 displays color selection interface 628. Color selection user interface 628 is a user interface for changing one or more attributes of output (e.g., light) at an external device, such as the foyer light. The one or more attributes can include a color attribute, a brightness attribute, and/or a temperature attribute with respect to the output of at the external device. As illustrated in FIG. 6H, color selection interface 628 includes color selection control region 630., which includes color control 630a, temperature control 630b, and swatch control 630c. As illustrated in FIG. 6H, color control 630a includes a bolded border to indicate that computer system 600 is displaying color selection interface 628. In some embodiments, in response to detecting an input directed to temperature control 630b, computer system 600 displays a temperature selection control (e.g., a control that, when selected, causes a temperature setting of a light and/or another type of output to be changed). In some embodiments, in response to detecting an input directed to swatch control 630c, computer system 600 displays a swatch control area (e.g., swatch control area 652, as described in more detailed in the discussion of FIG. 6K).

As illustrated in FIG. 6H, color selection interface 628 includes color control area 634 positioned beneath color selection indicator 632. As illustrated in FIG. 6H, color control area 634 includes color regions 634a-634e. At FIG. 6H, each of color regions 634a-634e represent different colors and/or color patterns of light (e.g., as indicated by the different hatchings in color regions 634a-634e). In some embodiments, when color grabber 690 is within a respective region, computer system 600 configures the foyer light to output light with the color indicated by the respective region. In some embodiments, when color grabber 690 is within a respective region while an input is detected (e.g., an input to apply the one or more attributes to the foyer light), computer system 600 re-displays the fill of foyer light slider control 620 with the color represented by the respective region. In some embodiments, computer system 600 positions color regions 634a-634e horizontally across the color control area 634 or in an orientation and/or arrangement that is different the orientation and arrangement illustrated in FIG. 6H. In some embodiments, computer system 600 displays more or less color regions 634a-634e than the number of regions illustrated in FIG. 6H.

As illustrated in FIG. 6H, color selection interface 628 also includes brightness selection indicator 636 and brightness selection control 638 positioned beneath color selection indicator 636. Computer system 600 displays brightness slide grabber 638a at a position on brightness selection control 638, which indicates that the current brightness of the foyer light is 50% (and which was set at FIG. 6G in response to detecting swipe input FIG. 6F). In some embodiments, in response to detecting one or more inputs directed to brightness selection control 638, computer system 600 causes the brightness of the foyer light to change. In some embodiments, computer system 600 changes color selection indicator 636 and/or the fill of brightness selection control 638 as color grabber 690 is moved within color control area 634 to reflect the region at which color grabber 690 is positioned. In some embodiments, changing the color selection indicator 636 and/or the fill of brightness selection control 638 indicates to the user how a change of brightness can impact the selected color (e.g., color selected by the position of color grabber 690).

As illustrated in FIG. 6H, color selection interface 628 includes favorites indicator 640, preview 642, saved profile controls 644a-644f, and add profile control 646. As illustrated in FIG. 6H, preview 642, saved profile controls 644a-644f, and add profile control 646 are positioned beneath favorites indicator 640. At FIG. 6H, computer system 600 displays a representation of the values selected on color control area 634 and brightness selection control 638 (and, in some embodiments, along with other values) in preview 642. In some embodiments, in response to detecting a change in one or more values of one or more attributes (e.g., color and/or brightness), computer system 600 updates the visual appearance of preview 642 to reflect the change in the one or more attributes.

As illustrated in FIG. 6H, color selection interface 628 also includes “saved profile” controls 644a-644f, “apply to this light” control 648, and “apply to more lights” control 650. In some embodiments, one or more of saved profile controls 644a-644f are pre-configured profiles provided by computer system 600. In some embodiments, one or more of saved profile controls 644a-644f is a representation of a combination of user-configurated attributes for one or more respective lights. In some embodiments, the one or more respective lights include the foyer light. In some embodiments, the one or more respective lights does not include the foyer light. In some embodiments, computer system 600 displays saved profile controls 644a-644f ordered with respect to being the most popular and/or favorited, last saved, most frequently used, and/or ranked by a user. As illustrated in FIG. 6H, computer system 600 displays add profile control 646. In some embodiments, computer system 600 displays add profile control 646 in an active state when color control area 634 and brightness selection control 638 are values that would create an appearance profile (e.g., a set of one or more attributes) not represented by one or more of saved profile controls 644a-644f. In some embodiments, computer system 600 displays add profile control 646 in an inactive state when color control area 634 and brightness selection control 638 are values that would not create an appearance profile (e.g., a set of one or more attributes) already represented by one or more of saved profile controls 644a-644f. In some embodiments, in response to detecting an input directed to saved profile controls 644a-644f while saved profile controls 644a-644f is inactive, computer system 600 does not perform one or more operations. At FIG. 6H, computer system 600 detects rightward swipe input 605h that travels from color region 634a toward color region 634c.

As illustrated in FIG. 6I, in response to detecting rightward swipe input 605h, computer system 600 moves color grabber 690 from color region 634a to color region 634c and updates preview 642 to reflect the change in the color value associated with the foyer light (e.g., no lines in preview 642 of FIG. 6I, which matches color region 634c not having any lines). In some embodiments, computer system 600 changes color selection indicator 636 and/or the fill of brightness selection control 638 to have a gradient and/or color represented by color region 634c in response to detecting rightward swipe input 605h.

Notably, at FIG. 6I, the shading of preview 642 does not change because the shading of preview 642 represents the brightness value of a light and the lines in FIG. 6I represent the color of the light. Hence, since the brightness value did not change in response to detecting rightward swipe input 605h, computer system 600 continues to display preview 642 in a manner that reflects that the brightness value did not change (e.g., shading of preview 642 of FIG. 6I is same as preview 642 of FIG. 6H). At FIG. 6I, computer system 600 detects tap input 605i directed to add profile control 646.

As illustrated in FIG. 6J, in response to detecting tap input 605i, computer system 600 displays saved control profile 644g adjacent to preview profile 642. Saved control profile 644g represents the appearance of a light corresponding to the values of attributes set while computer system 600 detected tap input 605i directed to add profile control 646. In other words, saved control profile 644g represents at least an appearance with a brightness value of 50% (e.g., as indicated by the position of brightness slide grabber 638a on brightness selection control 638 in FIG. 6I) and color value denoted by the position of color gabber 690 (e.g., color of color region 634c). As a part of displaying saved control profile 644g, computer system 600 shifts saved profile controls 644a-644f by one position to accommodate saved control profile 644g. As illustrated in FIG. 6J, computer system 600 also shifts add profile control 646 one position to accommodate saved control profile 644g. In some embodiments, computer system 600 displays more rows and columns of new saved profile controls as the number of saved profile controls increases. In some embodiments, computer system 600 ceases to display one or more of saved profile controls 644a-644f as the number of saved profile controls increases. In some embodiments, computer system 600 ceases to display the saved profile control that corresponds to the earliest saved appearance. In some embodiments, computer system 600 displays add profile control 646 adjacent to preview profile 642. In some embodiments, computer system 600 displays saved control profile 644g moving from preview profile 642 and getting smaller in size until saved control profile 644g is displayed at a new position adjacent to saved control profile 644f. In some embodiments, computer system 600 does not display saved control profile 644g at the position of saved control profile 644g in FIG. 6J until one or more attributes are changed, such that the one or more attributes represented by preview 642 does not match the one or more attributes represented by saved control profile 644g. At FIG. 6J, computer system 600 detects tap input 605j directed to swatch control 630c.

As illustrated in FIG. 6K, in response to detecting tap input 605j, computer system 600 ceases to display color control 630a with a bolded border to indicate that color control 630a is not selected and displays swatch control 630c with a bolded border to indicate that swatch control 630c is selected. In response to detecting tap input 605j, computer system 600 also replaces color control area 634 of FIG. 6J with swatch control area 652 while continuing to display other controls, such as saved profile controls 644a-644g. As illustrated in FIG. 6K, swatch control area 652 includes color swatches 652a-652l. At FIG. 6K, color swatches 652a-652l each represent a different Kelvin color, and computer system 600 has ordered color swatches 652a-652l from most to least popular Kelvin color. In some embodiments, computer system 600 orders color swatches 652a-652l from most to least popular to reduce the number of inputs that a user has to perform to navigate to the user's desired color swatch. In some embodiments, computer system 600 orders color swatches 652a-652l differently, such as based on frequency of use and/or recency of use. In some embodiments, the order of color swatches 652a-652l is determined dynamically. In some embodiments, one or more of color swatches 652a-652l are not Kelvin color swatches and are represented of another type of color and/or swatch. At FIG. 6K, computer system 600 detects swipe input 605k directed to swatch control area 652.

As illustrated in FIG. 6L, in response to detecting swipe input 605k, computer system 600 displays swatch control area 652 with color swatches 652m-652x. As illustrated in FIG. 6L, each of color swatches 652m-652x represent a different color and/or pattern of colors. In some embodiments, computer system 600 does not order color swatches 652m-652x using the same criteria (e.g., most popular, more recently used, and/or more frequently used) as computer system 600 used to order color swatches 652a-652l. At FIG. 6L, computer system 600 detects tap input 605l directed to color swatch 652r.

As illustrated in FIG. 6M, in response to detecting tap input 605l, computer system 600 updates preview 642 to indicate that color swatch 652r has been selected. Moreover, computer system 600 also displays color swatch 652r with a bolded border to indicate that color swatch 652r is now selected. In some embodiments, computer system 600 detects tap input 605m1 directed to apply to more lights control 650 at FIG. 6M. In some embodiments, in response to detecting tap input 650m1, computer system 600 causes the output of multiple external devices, including the foyer light, to have the attributes represented by preview 642. In some embodiments, computer system 600 detects tap input 605m1 directed to apply to this light control 648 at FIG. 6M. In some embodiments, in response to detecting tap input 605m1, computer system 600 causes the appearance of the output of the foyer light to have the attributes represented by preview 642.

FIGS. 6N-6S illustrates an exemplary scenario, where computer system 600 configures a different light to have the appearance with one or more attributes of a saved profile after the saved profile was saved via detecting one or more inputs.

FIG. 6N illustrates computer system 600 displaying home user interface 602 after the one or more changed attributes have been applied to the output of the foyer light (e.g., in response to detecting tap input 650m1 or 650m2). As illustrated in FIG. 6N, computer system 600 displays foyer light slider control 620 with the color that was represented by color swatch 652r of FIG. 6M (e.g., that was selected in response to detecting tap input 605l). In addition, at FIG. 6N, computer system 600 displays light attributes control 624 with a rainbow gradient filling the region 624a but not region interior to region 624a of light attributes control 624 (e.g., as indicated by hatchings in 624 of FIG. 6N). Notably, the gradient in region 624a of does not resemble the selected color (e.g., the color that was represented by color swatch 652r of FIG. 6M). In some embodiments, the color being in region 624a indicates that one or more attributes were changed and/or recently changed (e.g., as illustrated in FIG. 6N). At FIG. 6N, computer system 600 detects tap input 605n directed to close control 618b.

As illustrated in FIG. 6O, in response to detecting tap input 605n, computer system 600 displays home user interface 602, which includes island light control 610e and foyer light control foyer light control 612b. As illustrated in FIG. 6O, foyer light control status indicator 612b3 indicates that the foyer light is now on, which is due to the adjustments to the one or more attributes of the foyer light, as discussed above in relation to FIGS. 6N-6S. At FIG. 6O, computer system 600 detects tap input 605o directed to island light control 610e.

As illustrated in FIG. 6P, in response to detecting tap input 605o, computer system 600 displays island light slider control 660. Island light slider control 660 includes island light control graphical indicator 610el as illustrated in FIG. 6P. In some embodiments, in response to detecting tap input 605o, computer system 600 enlarges and/or expands island light slider control 660 similar to foyer light control 612b expansion discussed in FIGS. 6B-6D. As illustrated in FIG. 6P, light attributes control 624 includes a rainbow gradient color in region 624a and the region interior to region 624a, which indicates that values for color control area 634 and brightness selection control 638 have not been adjusted for island light slider control 660. At FIG. 6P, computer system 600 detects tap input 605p directed to light attributes control 624.

As illustrated in FIG. 6Q, in response to detecting tap input 605p, computer system 600 displays color selection interface 628. As illustrated in FIG. 6Q, color selection interface includes previously saved profile controls 644a-644g. Thus, in some embodiments, computer system 600 displays previously saved profile controls for an external device that were not being adjusted while the previously saved profile controls were saved. For example, computer system 600 displays saved profile control 644g while displaying controls that will cause computer system 600 to adjust one or more attributes of the island light to be adjusted at FIG. 6Q. Thus, in some embodiments, computer system 600 displays saved profile control 644g, irrespective of the device being adjusted while the profile was saved. In some embodiments, computer system 600 re-displays previously saved profile controls for some types of devices and does not re-display previously saved profile controls for other types of devices. In some embodiments, computer system 600 re-displays different set of previously saved profile controls for different types of devices (e.g., one set of controls for lights and another set of controls for door locks and/or one set of controls for can lights and another set of controls for lights that are not can lights). At FIG. 6Q, computer system 600 detects tap input 605q directed to saved profile control 644a.

As illustrated in FIG. 6R, in response to detecting tap input 605r, computer system 600 displays color grabber 690 positioned on region 634c of color control area 634. Computer system 600 also displays a representation of the values selected on color control area 634 and brightness selection control 638 in preview 642. At FIG. 6R, the representations of the values match the values that were previously saved in response to detecting tap input 605i at FIG. 6I. Thus, at FIG. 6R, computer system 600 is configured to cause the output of the island light to have the same appearance as the appearance the output of the foyer light was configured to cause in FIGS. 6I-6J. At FIG. 6R, computer system 600 detects tap input 605r directed to apply to this light control 648.

As illustrated in FIG. 6S, in response to detecting tap input 605r, computer system 600 displays island light slider control 660 including island light control graphical indicator 610e1. Also as illustrated in FIG. 6S, in response to detecting tap input 605r, computer system 600 displays the fill in island light slider control 660 to correspond with the values selected on color control area 634 and brightness selection control 638 in FIG. 6R (e.g., the values of the attributes for the saved profile corresponding to saved control profile 644a of FIG. 6Q). At FIG. 6S, computer system 600 detects tap input 605s directed to apply to close control 618b.

As illustrated in FIG. 6T, in response to detecting tap input 605s, computer system 600 displays home user interface 602, which includes sprinkler control 610c. At FIG. 6T, computer system 600 detects tap input 605t directed to sprinkler control 610c.

As illustrated in FIG. 6U, in response to detecting tap input 605t, computer system 600 displays sprinkler control interface 670. Sprinkler control interface 670 includes sprinkler zone 1 control 670a, sprinkler zone 2 control 670b, sprinkler zone 3 control 670c, and sprinkler zone 4 control 670d. Each of the sprinkler zones displayed in FIG. 6U correspond to a lawn sprinkler. As illustrated, in FIG. 6U, computer system 600 displays the individual statuses of the corresponding lawn sprinklers are displayed (e.g., as shown by zone 1 being on, zone 2, zone 3, and zone 4 being off).

FIG. 7 is a flow diagram illustrating a method (e.g., method 700) for managing an appearance of output for an external device in accordance with some examples. Some operations in method 700 are, optionally, combined, the orders of some operations are, optionally, changed, and some operations are, optionally, omitted.

As described below, method 700 provides an intuitive way for managing an appearance of output for an external device. Method 700 reduces the cognitive burden on a user for managing an appearance of output for an external device, thereby creating a more efficient human-machine interface. For battery-operated computing devices, enabling a user to manage an appearance of output for an external device faster and more efficiently conserves power and increases the time between battery charges.

In some embodiments, method 700 is performed at a computer system (e.g., 600) that is in communication with a display generation component (e.g., a display, a touch-sensitive display, a projector, a light, and/or a set of one or more light emitting diodes) and one or more input devices. In some embodiments, the computer system is a phone, a watch, a tablet, a fitness tracking device, a wearable device, a television, a multi-media device, an accessory, a speaker, a head-mounted display (HMD), and/or a personal computing device. In some embodiments, the computer system is in communication with input devices and/or output devices, such as one or more cameras, speakers, microphones, sensors (e.g., heart rate sensor, monitors, antennas (e.g., using Bluetooth and/or Wi-Fi), and/or near-field communication sensors).

At 702, the computer system displays, via the display generation component, a first user interface (e.g., user interface including 620 in FIG. 6E) that includes (at 704) a representation of a setting (e.g., 620) for an external device. In some embodiments, the external device includes (or is) a computer system as described above, is a light, a television, a garage opener, a smart appliance, a stereo, a speaker and/or a thermostat.

At 702, the computer system displays, via the display generation component, the first user interface that includes (at 706) a first control (e.g., 624) (e.g., an appearance picker control and/or a control for displaying one or more options for changing one or more attributes of the external device's output). In some embodiments, the representation of the setting is displayed concurrently with the one or more appearance controls.

At 708, while displaying the first user interface (e.g., user interface including 620 in FIG. 6E) that includes the representation of the setting (e.g., 620) that corresponds to the external device and the first control (e.g., 624), the computer system detects, via the one or more input devices, an input directed to the first control (e.g., 605g).

At 710, the computer system in response to detecting the input directed to the first control, displaying, via the display generation component, a second user interface that includes: (at 712) a second control (e.g., 646) for saving an appearance of one or more appearance attributes of output for the setting (e.g., output that is currently being output and/or is to be output by and/or at the external device).

At 710, the computer system in response to detecting the input directed to the first control, displaying, via the display generation component, a second user interface that includes: (at 714) a set of one or more controls (e.g., 634 and/or 638) for adjusting the one or more appearance attributes (e.g., color, tint, brightness, hue, intensity, form, direction, movement, one or more attributes of light, and/or one or more attributes of color) of output for the setting.

At 716, while displaying the second user interface (e.g., 628) that includes the second control (e.g., 646) and the set of one or more controls (e.g., 634 and/or 638), the computer system detects, via the one or more input devices, a first set of one or more inputs (e.g., 605h) (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or more controls.

At 718, in response to detecting the first set of one or more inputs (e.g., 605h) directed to the set of one or more controls (e.g., 634 and/or 638), the computer system changes one or more representations of the one or more appearance attributes of output for the setting. In some embodiments, in response to detecting the first set of one or more inputs directed to the set of one or more controls, the computer system updates a representation of the current appearance and/or a representative appearance of the output for the setting and/or at the external device.

At 720, after (e.g., while and/or in conjunction with) the one or more representations of the one or more appearance attributes of output for the setting are changed and while displaying the second control (e.g., 646), the computer system detects, via the one or more input devices, a first input (e.g., 605i) (e.g., a tap input and/or in some embodiments, a non-tap input, such as an air input (e.g., a pointing air gesture, a tapping air gesture, and/or a moving air gesture), a gaze input, a mouse click input, a voice command, and/or a selection input (e.g., such as moving the computer system in a particular direction)) directed to the second control.

At 722, in response to detecting the first input (e.g., 605i) directed to the second control (e.g., 646), the computer system saves an appearance of output for a respective setting (e.g., 644a in FIG. 6L) (e.g., for the external device and/or another device) that includes the changed one or more appearance attributes. In some embodiments, in response to detecting the second input directed to the second control, the computer system displays, via the display generation component, a representation of the appearance of output of the external device that includes the adjusted one or more appearance attributes. In some embodiments, the representation of the appearance of output of the external device that includes the adjusted one or more appearance attributes was not previously displayed before detecting the second input directed to the second control. Saving an appearance of output for a respective setting that includes the changed one or more appearance attributes via the display generation component in response to detecting the first input directed to the second control enables a computer system to save setting of a device (e.g., for later use), thereby reducing the number of inputs needed to perform an operation.

In some embodiments, the second user interface (e.g., 628) includes a first group of appearance representations (e.g., a group of saved appearance representations, commonly used appearance representations, predefined appearance representations, system generated, and/or defined appearance representations) that includes a first representation of a first appearance of output for the external device and a second representation of a second appearance of output for the external device. In some embodiments, in response to detecting the first input (e.g., 605i) directed to the second control (e.g., 646), the computer system displays at a terminal position (e.g., 644a) (e.g., beginning and/or end in a line of representations of predefined appearances and/or perimeter of a shape of the group of representations) in the first group of appearance representations (e.g., 644a-644d), via the display generation component, a first representation of the appearance of output (e.g., 644a) for the respective setting that includes the changed one or more appearance attributes (e.g., 644a). Displaying, at a terminal position, a representation of the appearance of output for a respective setting that includes the changed one or more appearance attributes in response to detecting the first input directed to the second control allows the computer system to provide an update to the user concerning the change to the appearance of output and a control to the user to the change in the appearance of output, thereby reducing the number of inputs needed to perform an operation and providing the user with additional control options.

In some embodiments, the one or more appearance attributes of output for the external device adjusted in response to detecting the first set of one or more inputs (e.g., 605h) directed to the set of one or more controls (e.g., 634 and/or 638) is adjusted to a first state (e.g., a first adjustment state and/or a state where one or more attributes are set to one or more particular values). In some embodiments, the second user interface (e.g., 628) includes a second group of appearance representations (e.g., 644e-644f) (e.g., a group of saved appearance representations, commonly used appearance representations, predefined appearance representations, system generated, and/or defined appearance representations) that includes a third representation of a third appearance of output for the external device and a representation of the one or more appearance attributes of output for the external device adjusted to the first state. In some embodiments, the representation of the one or more appearance attributes of output for the external device adjusted to the first state is displayed at a terminal position (e.g., 644f) in the second group of appearance representations. In some embodiments, while displaying the second user interface (e.g., 628) that includes the second control (e.g., 646) and the set of one or more controls (e.g., 634 and/or 638), detecting, via the one or more input devices, a second set of one or more inputs (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or more controls. In some embodiments, in response to detecting the second set of one or more inputs directed to the set of one or more controls (e.g., 634 and/or 638), adjusting the one or more appearance attributes of output to a second state different from the first state. In some embodiments, while the one or more appearance attributes of output for the external device are adjusted to the second state and while displaying the second control (e.g., 646), detecting, via the one or more input devices, a second input (e.g., 605i) (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the second control. In some embodiments, in response to detecting the second input (e.g., 605i) directed to the second control. In some embodiments, displaying, via the display generation component, the representation of the one or more appearance attributes of output for the external device adjusted to the first state in a first position (e.g., 644e) in the second group of appearance representations different from the terminal position in the second group of appearance representations (e.g., 644f). In some embodiments, in response to detecting the third input directed to the second control, the representation of the one or more appearance attributes of output of the external device adjusted to the first state moves from the terminal position to the first position. In some embodiments, displaying, via the display generation component, the representation of the one or more appearance attributes of output for the external device adjusted to the second state in the terminal position (e.g., 644g). Displaying the representation of the one or more appearance attributes of output for the external device adjusted to the first state in the first position and displaying the representation of the one or more appearance attributes of output for the external device adjusted to the second state in the terminal position in response to detecting the second input directed to the second control allows the computer system to display multiple representations of appearance attributes of output for an external device based on when/if a representation was saved, thereby providing improved visual feedback to the user, reducing the number of inputs needed to perform an operation, and providing the user with additional control options.

In some embodiments, the second control (e.g., 646) is displayed at a second position before detecting the second input directed to the second control. In some embodiments, in response to detecting the first input (e.g., 605i) directed to the second control (e.g., 646), the computer system displays, via the display generation component, the second control at a third position different from the second position. In some embodiments, in response to detecting the first input directed to the second control, the computer system moves display of the second control from the second position to the third position. In some embodiments, in response to detecting the first input directed to the second control, the computer system moves display of other controls to different positions than they were displayed previously. In some embodiments, in response to detecting the first input directed to the second control, the computer system does not move display of other controls to different positions than they were displayed previously (e.g., other controls in the set of one or more controls). Displaying the control at a third position (e.g., after the control was displayed at the second position) in response to detecting the first input directed to the second control enables a computer system to reorder and display the control at a different position so that the control is more accessible to the user, thereby providing improved visual feedback to the user, reducing the number of inputs needed to perform an operation, and providing additional control options without cluttering the user interface with additional displayed control.

In some embodiments, the second user interface (e.g., 628) includes a first preview area (e.g., 642) (e.g., a dedicated area of the user interface, a square, and/or a circle) with a second representation of the appearance of output for the external device that is updated based on inputs (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set or one or more controls. In some embodiments, while displaying the second user interface (e.g., 628) that includes the second control (e.g., 646) and the set of one or more controls (e.g., 634 and/or 638), the computer system detects, via the one or more input devices, a third set of one or more inputs (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or more controls. In some embodiments, in response to detecting the third set of one or more inputs directed to the set of one or more controls (e.g., 634 and/or 638), the computer system adjusts the one or more appearance attributes of output to a third state (e.g., based on the third set of one or more inputs). In some embodiments, the computer system displays, via the display generation component, the first preview area (e.g., 642) with a third representation of the appearance of output for the external device at the third state. In some embodiments, while displaying the first preview area (e.g., 642) with the third representation of the appearance of output for the external device at the third state, the computer system detects, via the one or more input devices, a fourth set (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) of one or more inputs directed to the set of one or more controls (e.g., 634 and/or 638). In some embodiments, in response to detecting the fourth set of one or more inputs directed to the set of one or more controls (e.g., 634 and/or 638), the computer system adjusts the one or more appearance attributes of output to a fourth state. In some embodiments, the computer system displays, via the display generation the first preview area (e.g., 642) with the third representation of the appearance of output for the external device at the third state changing to a fourth representation of the appearance of output for the external device at the fourth state. Displaying the first preview area with the third representation of the appearance of output for the external device at the third state changing to the fourth representation of the appearance of output for the external device at the fourth state in response to detecting the fourth set of one or more inputs directed to the set of one or more controls enables a computer system to display updates on how the appearance of output for an external device is being adjusted by the computer system, thereby providing improved visual feedback to the user, reducing the number of inputs needed to perform an operation and providing additional control options.

In some embodiments, the one or more appearance attributes includes a brightness attribute (e.g., 638) (e.g., a lux value, a lumens value, and/or a brightness of a light). In some embodiments, a control of the set of one or more controls corresponds to the brightness attribute (and, in some embodiments, does not correspond to a different appearance attribute of the one or more appearance attributes). Changing one or more appearance attributes that includes a brightness attribute and saving an appearance of output for a respective setting that includes the changed one or more appearance attributes via the display generation component in response to detecting the first input directed to the second control enables a computer system to save setting of a device that includes brightness (e.g., for later use), thereby reducing the number of inputs needed to perform an operation.

In some embodiments, the one or more appearance attributes includes a color characteristic (e.g., 634) (e.g., color, hue, tone, attribute, and/or saturation). In some embodiments, a control of the set of one or more controls corresponds to the color attribute (and, in some embodiments, does not correspond to a different appearance attribute of the one or more appearance attributes). Changing one or more appearance attributes that includes a color characteristic and saving an appearance of output for a respective setting that includes the changed one or more appearance attributes via the display generation component in response to detecting the first input directed to the second control enables a computer system to save a setting of a device that includes the color characteristic (e.g., for later use), thereby reducing the number of inputs needed to perform an operation.

In some embodiments, while the appearance of output for the respective setting that includes the changed one or more appearance attributes is saved, the computer system detects a request (e.g., 605m2) to display a user interface for a second external (e.g., user interface shown in FIG. 6Q) device different from the external device. In some embodiments, as a part of detecting the request to display the user interface for the second external device, the computer system detects one or more tap inputs and/or, in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction. In some embodiments, in response to detecting the request to display the user interface for the second external device, the computer system displays, via the display generation component, the user interface for the second external device, wherein the user interface for the second external device (e.g., user interface shown in FIG. 6Q) includes: the second control (e.g., 646) for saving an appearance of one or more appearance attributes of output for the setting for the second external device and a second representation (e.g., 644e) of the appearance of output for the respective setting that includes the changed one or more appearance attributes. Displaying a user interface for a second external device, where displaying the user interface includes a second control for saving an appearance of one or more appearance attributes of output for a setting of the second external device and a second representation of the appearance of output for the respective setting that includes the changed one or more appearance attributes in response to detecting a request to display the user interface for the second external device enables a computer system provide a representation of the appearance of output for the respective setting that includes the changed one or more appearance attributes, where the one or more attributes were changed with respect to another device, thereby reducing the number of inputs needed to perform an operation and providing additional control options.

In some embodiments, the user interface for the second external device (e.g., user interface in FIG. 6Q) includes a second preview (e.g., 642) with a representation of the appearance of output for the second external device that does not correspond to the appearance of output for the respective setting that includes the changed one or more appearance attributes. In some embodiments, while displaying the second representation of the appearance of output for the respective setting that includes the changed one or more appearance attributes, the computer system detects, via the one or more input devices, an input (e.g., 605q) (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the second representation of the appearance of output for the respective setting that includes the changed one or more appearance attributes. In some embodiments, in response to detecting the input directed to the second representation of the appearance of output for the respective setting that includes the changed one or more appearance attributes, the computer system displays, via the display generation component, a representation of the appearance of output for the second external device (e.g., 642 in FIG. 6R) corresponding to the appearance of output for the respective setting that includes the changed one or more appearance attributes. Displaying the representation of the appearance of output for a second external device corresponding to the appearance of output for the respective setting that includes the changed one or more appearance attributes in response to detecting an input directed to the second representation of the appearance of output for the respective setting that includes the changed one or more appearance attributes enables a computer system to provide the user with an option to change an appearance of output for the second external device based on one or more changed attributes that were saved while adjusting the output of another device, thereby reducing the number of inputs needed to perform an operation and providing additional control options.

In some embodiments, the second user interface (e.g., 628) includes a third control (e.g., 630c). In some embodiments, while displaying the third control, the computer system detects, via the one or more input devices, an input (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the third control (e.g., 605j). In some embodiments, in response to detecting the input directed to the third control, the computer system displays, via the display generation component, a first set of one or more color representations (e.g., 652a-652l) (e.g., Kelvin color representations, the most popular color representations (e.g., for a particular user and/or multiple users), and/or the most frequently used representations (e.g., for a particular user and/or multiple users)). Displaying a first set of one or more color representations, in response to detecting the input directed to the third control enables the computer system to provide a user with a variety of colors not previously presented to the user, thereby reducing the number of inputs needed to perform an operation and providing additional control options.

In some embodiments, the second user interface (e.g., 628) includes a fifth control (e.g., 652) different from the first control (e.g., 624) and a sixth control (e.g., 638) different from the first control and the fifth control. In some embodiments, in response to detecting the input directed to the third control (e.g., 605c), the computer system ceases to display the fifth control. In some embodiments, the computer system continues to display the sixth control. In some embodiments, in response to detecting the input directed to the third control, the computer system replaces the fifth control with the second control and/or another control. In some embodiments, the fifth control and the sixth controls are in the set of one or more controls. In some embodiments, the fifth control, when selected, causes the computer system to cause output of the external device to be adjusted. In some embodiments, the sixth control, when selected, causes the computer system to cause output of the external device to be adjusted (e.g., in a different manner than what the fifth control causes the computer system to cause output of the external device to be adjusted when selected). Continuing to display the fifth control and ceasing to display the sixth control in response to detecting an input directed to the third control enables a computer system to replace some controls previously displayed controls with other controls while continuing to display some of the previously displayed controls, thereby providing additional control options without cluttering the user interface with additional display controls.

In some embodiments, in response to detecting the second input directed to the second control (e.g., 646), the second user interface (e.g., 628) includes a third representation of the appearance of output for the respective setting that includes the changed one or more appearance attributes. In some embodiments, in response to detecting the input directed to the third control (e.g., 630j), the computer system continues displaying the third representation of the appearance of output for the respective setting that includes the changed one or more appearance attributes. Displaying a representation of an appearance of output for a respective setting of an external device that includes the changed one more appearance attributes in response to detecting an input directed to the third control enables a computer to provide a user with certain controls that continue to be displayed even as other controls are changed, thereby providing additional control options without cluttering the user interface with additional display control.

In some embodiments, while displaying the first set of one or more color representations, the computer system detects, via the one or more input devices, an input (e.g., one or more tap inputs and/or in some embodiments, one or more non-tap inputs, such as air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the first set of one or more color representations (e.g., 605k). In some embodiments, in response to detecting the input directed to the first set of one or more color representations, the computer system displays, via the display generation component, a second set of one or more color representations (e.g., 652m-652x) different from the first set of one or more color representations, wherein at least one color represented in the second set one or more color representations is a less common color (e.g., less popular, less used, less desired, less frequently used, and/or less used recently) than the one or more colors represented in the first set of one or more color representations. Displaying a second set of one or more color representations different from the first set of one or more color representations, where at least one color represented in the second set one or more color representations is a less common color, in response to detecting an input directed to the first set of one or more color representations enables the computer system to present a user with color operations in an order of what is likely to be most to least desirable to a user, thereby providing additional control options without cluttering the user interface with additional display controls, reducing the number of inputs needed to perform an operation, and providing improved visual feedback to the user.

In some embodiments, the first control (e.g., 624) is concurrently displayed with a fourth control. In some embodiments, while concurrently displaying the first control (e.g., 624) and the fourth control (e.g., 622), the computer system detects an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the fourth control (e.g., 622). In some embodiments, in response to detecting the input directed to the fourth control (e.g., 622), the computer system initiates a process to configure the first external device for automatic adjustment (e.g., without detecting, via the one or more input devices, an input corresponding to a request to adjust the first external device at the time of adjustment). In some embodiments, initiating the process to configure the first external device for automatic adjustment includes displaying one or more settings that, when selected, allow the first external device and/or the computer system to automatically adjust a characteristic (e.g., lighting and/or brightness) of the first external device based on context (e.g., environmental context and/or user context). Initiating a process to configure an external device for automatic adjustment in response to detecting the input directed to the fourth control provides the user with control over the computer system to place the computer system in a mode to cause an external device to automatically adjust, thereby reducing the number of inputs needed to perform an operation and providing additional control options without cluttering the user interface with additional display controls.

In some embodiments, the second user interface (e.g., 628) includes a fifth control (e.g., 648). In some embodiments, while displaying the second user interface (e.g., 628) includes the fifth control and while the one or more representations of the one or more appearance attributes of output for the setting is changed, the computer system detects, via the one or more input devices, an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the fifth control (e.g., 605m2). In some embodiments, in response to detecting the input directed to the fifth control, the computer system changes output of the external device to include the changed one or more appearance attributes (e.g., without changing output of another external device). In some embodiments, the computer system changes output of the external device to include the changed one or more appearance attributes by sending one or more instructions to the external device, where the one or more instructions cause the external device to change the output of the external device. Changing output of an external device to include the changed one or more appearance attributes in response to detecting the input directed to the fifth control provides the user with control over the computer system to change the one or more appearance attributes of an external device, thereby providing additional control options without cluttering the user interface with additional display controls and reducing the number of inputs needed to perform an operation.

In some embodiments, the second user interface (e.g., 628) includes a sixth control (e.g., 650). In some embodiments, while displaying the second user interface (e.g., 628) including the sixth control and while the one or more representations of the one or more appearance attributes of output for the setting is changed, the computer system detects, via the one or more input devices, an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the sixth control (e.g., 605m1). In some embodiments, in response to detecting the input directed to the sixth control, the computer system changes output for a plurality of external devices to include the changed one or more appearance attributes, wherein the plurality of external devices includes the external device. In some embodiments, the computer system changes output of the plurality of external devices to include the changed one or more appearance attributes by sending one or more instructions to the plurality of external devices, where the one or more instructions cause the plurality of external devices to change each of their respective outputs. Changing output for a plurality of external devices to include the changed one or more appearance attributes in response to detecting the input directed to the sixth control provides the user with control over the computer system to change the one or more appearance attributes of an external device, thereby providing additional control options without cluttering the user interface with additional display controls and reducing the number of inputs needed to perform an operation.

In some embodiments, before detecting the input directed to the first control (e.g., 605g), the first control (e.g., 624) includes a first visual appearance (e.g., 624 in FIG. 6G). In some embodiments, while displaying the second user interface (e.g., 628), the computer system detects a request to cease displaying the second user interface. In some embodiments, detecting the request to cease displaying the second user interface includes detecting one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction. In some embodiments, in response to detecting the request to cease displaying the second user interface (e.g., 628), the computer system ceases displaying the second user interface. In some embodiments, after displaying the second user interface (e.g., 628) and after receiving a request to re-display the first user interface (e.g., user interface including 620 in FIG. 6E) (e.g., the request to cease displaying the second user interface and/or another request different from the request to cease displaying the second user interface), the computer system re-displays the first user interface, wherein, in accordance with a determination that output of external device was changed in response to detecting one or more inputs directed to the second user interface (e.g., 628), the first control (e.g., 624) is displayed with a second visual appearance (e.g., 624 in FIG. 6N) (e.g., an appearance that includes one or more colors that are reflective of the appearance of output of the external device, an appearance that does not include a rainbow gradient and/or multiple colors displayed on the edge of the second control, and/or an appearance that does include the rainbow gradient and/or multiple colors displayed on the edge of the second control) that is different from the first visual appearance; and in accordance with a determination that output of external device was not changed in response to detecting one or more inputs directed to the second user interface (e.g., 628), the first control (e.g., 624) is displayed with the first visual appearance (e.g., an appearance that includes one or more colors that are not reflective of the appearance of output of the external device, an appearance that includes a rainbow gradient and/or multiple colors displayed on the edge of the second control, and/or an appearance does not include a rainbow gradient and/or multiple colors displayed on the edge of the second control). Displaying a first control with a particular visual appearance based on prescribed conditions being met allows the computer system to automatically choose to display the first control with a different visual appearance based on whether or not the output of the external device has changed, thereby performing an operation when a set of conditions has been met without requiring further user input and providing improved visual feedback to the user.

In some embodiments, the second visual appearance (e.g., 624 in FIG. 6N) does not include a representation of the one or more appearance attributes of output for the setting. In some embodiments, the second visual appearance does not resemble and/or include one or more of the changed attributes.

In some embodiments, the first user interface (e.g., user interface including 620 in FIG. 6E) includes a control with a portion that includes a visual appearance (e.g., 620 in FIG. 6G) that corresponds to the changed output of the external device. In some embodiments, the portion is a fill bar. In some embodiments, the fill bar represents the changed output of the external device. In some embodiments, in response to detecting an input directed to the portion, the computer system changes a first respective attribute (e.g., brightness and/or amount of light) of the appearance of output of the external device without changing a second respective attribute (e.g., color, saturation, tone, and/or warmth) of the appearance of output of the external device. Displaying a first user interface with a control having a visual appearance that corresponds to the change made to the output of the external device enables the computer system to provide a user with representation of the output of the external device, thereby providing improved visual feedback to the user and providing additional control options without cluttering the user interface with additional displayed controls.

In some embodiments, while changing one or more representations of the one or more appearance attributes of output for the setting, displaying, via the display generation component, a fourth representation of the appearance of output (e.g., 642) for the respective setting that updates based on the one or more appearance attributes being changed in a third group of appearance representations (e.g., a group of saved appearance representations, commonly used appearance representations, predefined appearance representations, system generated, and/or defined appearance representations). In some embodiments, the representation of the saved appearance is updated as the color of the appearance of output is updated. Displaying a fourth representation of the appearance of output for the respective setting that updates based on the one or more appearance attributes being changed in a third group of appearance representations while changing one or more representations of the one or more appearance attributes of output enables the computer system to provide a user with a representation of the changes to the appearance of output for the external device, thereby providing improved visual feedback to the user.

In some embodiments, after detecting second input directed to the second control (e.g., 646), via the one or more input devices, detecting, via the display generation component, an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or controls. In some embodiments, in response to detecting the input directed to the set of one or more controls (e.g., 634 and/or 638), the computer system displays, via the display generation component, a fourth representation of the appearance of output for the respective setting in a fourth group of appearance representations (e.g., a group of saved appearance representations, commonly used appearance representations, predefined appearance representations, system generated, and/or defined appearance representations). In some embodiments, in response to detecting the input directed to the set of one or more controls, the computer system moves a representation of the appearance of output for the respective setting into the group of appearance representations. Displaying a fourth representation of the appearance of output for the respective setting in a fourth group of appearance representations in response to detecting the input directed to the set of one or more controls enables the computer system to display a newly saved representation of an appearance of output, thereby providing improved visual feedback to the user and providing additional control options without cluttering the user interface with additional displayed control.

In some embodiments, after detecting second input directed to the second control (e.g., 646), via the one or more input devices, detecting, via the display generation component, an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or controls; and In some embodiments, in response to detecting the input directed to the set of one or more controls (e.g., 634 and/or 638), the computer system displays, via the display generation component, a fourth representation of the appearance of output for the respective setting in a fourth group of appearance representations (e.g., a group of saved appearance representations, commonly used appearance representations, predefined appearance representations, system generated, and/or defined appearance representations). In some embodiments, in response to detecting the input directed to the set of one or more controls, the computer system moves a representation of the appearance of output for the respective setting into the group of appearance representations. Displaying a fourth representation of the appearance of output for the respective setting in a fourth group of appearance representations in response to detecting the input directed to the set of one or more controls enables the computer system to display a newly saved representation of an appearance of output, thereby providing improved visual feedback to the user and providing additional control options without cluttering the user interface with additional displayed control.

In some embodiments, the second user interface (e.g., 628) includes a third preview of output for the external device and a fifth representation of the appearance of output for the respective setting in a fifth group of appearance representations (e.g., a group of saved appearance representations, commonly used appearance representations, predefined appearance representations, system generated, and/or defined appearance representations) that was displayed in response to detecting the second input directed to the second control (e.g., 646), the method further comprising: after displaying the input directed to the set of one or more controls (e.g., 634 and/or 638) and while displaying the fifth representation of the appearance of output for the respective setting in the fifth group of appearance representations and the third preview of output for the external device, detecting a second set of one or more inputs (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the set of one or more controls; and in response to detecting the second set of one or more inputs directed to the set of one or more controls (e.g., 634 and/or 638): changing one or more representations of the one or more appearance attributes of output for the setting; and updating the third preview of output for the external device. Updating the third preview of output for the external device and changing one or more representations of the one or more appearance attributes of output for the setting in response to detecting the second set of one or more inputs directed to the set of one or more controls enables a computer system to provide a user with a preview of the changes that are occurring in response to detecting input from the user, thereby by providing improved visual feedback to the user and providing additional control options without cluttering the user interface with additional displayed control.

In some embodiments, in response to detecting the second set of one or more inputs directed to the set of one or more controls (e.g., 634 and/or 638), the computer system continues to display the fifth representation (e.g., 644e) of the appearance of output for the respective setting in the fifth group of appearance representations without updating the fifth representation of the appearance of output for the respective setting in the fifth group of appearance representations. In some embodiments, the representation of the saved appearance is not modified in response to detecting the second set of one or more inputs directed to the set of one or more controls. Continuing to display the fifth representation of the appearance of output for the respective setting in the fifth group of appearance representations without updating the fifth representation of the appearance of output for the respective setting in the fifth group of appearance representations in response to detecting the second set of one or more inputs directed to the set of one or more controls enables a computer system to prevent the loss of a previously saved representation of an appearance of output, thereby by providing improved visual feedback to the user, performing an operation when a set of conditions has been met without requiring further user input, and reducing the number of inputs needed to perform an operation.

In some embodiments, in response to detecting an input directed to the second control (e.g., save function), one or more appearance attributes of output of the external device (e.g., previously saved) ceases to be displayed.

Note that details of the processes described above with respect to method 700 (e.g., FIG. 9) are also applicable in an analogous manner to other methods described herein. For example, method 700 optionally includes one or more of the characteristics of the various methods described above with reference to method 900. For example, one or more steps of method 600 for managing an appearance of output for an external device can be displayed while managing a control for operating various modes of the external device using one or more steps of method 900. For brevity, these details are not repeated below.

FIG. 9 is a flow diagram illustrating a method (e.g., method 900) for managing a control for operating various modes of the external device in accordance with some examples. Some operations in method 900 are, optionally, combined, the orders of some operations are, optionally, changed, and some operations are, optionally, omitted.

As described below, method 900 provides an intuitive way for managing a control for operating various modes of an external device. Method 900 reduces the cognitive burden on a user for managing a control for operating various modes of an external device, thereby creating a more efficient human-machine interface. For battery-operated computing devices, enabling a user to manage a control for operating various modes of an external device faster and more efficiently conserves power and increases the time between battery charges.

In some embodiments, method 900 is performed at a computer system (e.g., 600) that is in communication with a display generation component (e.g., a display, a touch-sensitive display, a projector, a light, and/or a set of one or more light emitting diodes). In some embodiments, the computer system is a phone, a watch, a tablet, a fitness tracking device, a wearable device, a television, a multi-media device, an accessory, a speaker, a head-mounted display (HMD), and/or a personal computing device. In some embodiments, the computer system is in communication with input devices and/or output devices, such as one or more cameras, speakers, microphones, sensors (e.g., heart rate sensor, monitors, antennas (e.g., using Bluetooth and/or Wi-Fi), and/or near-field communication sensors).

At 902, the computer system receives a request (e.g., 805a) (e.g., to display a control or a scale, to set a temperature setting, to display a user interface, and/or to perform an operation) (e.g., via one or more inputs directed to a control, such as a tap input, a gaze input, a swipe input, a selection input, a mouse click, and/or an air input (e.g., a pointing input, an air tap input, and/or a hand clenching input)).

At 904, in response to receiving the request (e.g., 805a), the computer system displays, via the display generation component, a user interface (e.g., 800) that include an indication of a current selected value for a setting (e.g., 806c) (e.g., a temperature setting, a door setting, a light setting, and/or a sound setting). In some embodiments, the setting is a setting of an output of another device, such as the temperature output by an HVAC unit, an air conditioner, a heater, and/or a fan; one or more characteristics (e.g., color, brightness, hue, and/or angle of light) of light output by a light bulb; the position of an actuator and/or state of a motor of a window, set of blinds, front door, and/or light; and/or one or more sound characteristics (e.g., bass, treble, and/or volume) output by a speaker.

At 904, in response to receiving the request (e.g., 805a), the computer system displays, via the display generation component, the user interface that include a representation of a control (e.g., a user interface object, a scale, and/or a representation of a range of values) for the setting (e.g., 890) (e.g., a groove, a bar, and/or a background representing the scale), wherein: the computer system displays, via the display generation component, a user interface that include an indication of a current selected value for a setting and a representation of a control, in accordance with (at 906) a determination that the computer system (e.g., 600) is operating in a first mode (e.g., 808c) for the first setting while the indication of the current selected value (e.g., 890) for the setting is displayed at a first position relative to (e.g., a position that is adjacent to, on, inside of, and/or output side of) the representation of the control (e.g., 806), the computer system displays, via the display generation component, a first section of the representation of the control (e.g., 806a) and a second section of the representation of the control (e.g., 806b) for the setting with a first gradient (e.g., circles in 806a), wherein the second section of the control is closer to the first position than the first section of the control, and wherein display of the first gradient expands across the first section of the representation of the control and the second representation of the control. In some embodiments, the first position is relative to the user interface and/or display (e.g., at and/or on a particular location on the user interface and/or on the screen). In some embodiments, the first section starts and/or ends at an edge of the representation of the scale. In some embodiments, the second section does not start and/or end at an edge of the representation of the scale. In some embodiments, the edge of the representation of scale represents and/or is near the minimum value for the setting and/or the maximum value for the setting. In some embodiments, the first section and the second section are connected and/or continuous, such that no other sections of the representation of the scale are between the first section and the second section. In some embodiments, the first gradient displayed and/or with the second section is a continuation of the first gradient displayed and/or with the first section.

At 904, in response to receiving the request, the computer system displays, via the display generation component, a user interface that include an indication of a current selected value for a setting and a representation of a control, in accordance with (at 908) a determination that the computer system (e.g., 600) is operating in a second mode (e.g., 808b), the computer system different from the first mode (e.g., 808c), for the first setting while the indication of the current selected value for the setting (e.g., 890) is displayed at the first position relative to (e.g., a position that is adjacent to, on, inside of, and/or outside of) the representation of the control (e.g., 806), displaying, via the display generation component, the first section of the representation of the control (e.g., 806a) with the first gradient (e.g., circles in 806a) while displaying, via the display generation component, the second section of the representation of the control (e.g., 806b) with a second gradient (e.g., circles shown in 806b) different from the first gradient in accordance with a determination that the computer system (e.g., 600) is operating in a second mode (e.g., 808b), different from the first mode (e.g., 808c), for the first setting while the indication of the current selected value for the setting (e.g., 890) is displayed at the first position relative to (e.g., a position that is adjacent to, on, inside of, and/or outside of) the representation of the control (e.g., 806), displaying, via the display generation component, the first section of the representation of the control (e.g., 806a) with the first gradient (e.g., circles in 806a) while displaying, via the display generation component, the second section of the representation of the control (e.g., 806b) with a second gradient (e.g., circles shown in 806b) different from the first gradient. In some embodiments, when the second section is displayed with the second gradient, display of the first gradient does not expand across of the first section and the second section. In some embodiments, the second gradient is not a continuation of the first gradient and/or has a different hue and/or primary color than the first gradient. Displaying a first section of a representation of a control and a second section of the representation of the control with a first gradient expanding across the first section and the second section based on the computer system operating in a first mode and a first setting or displaying the first section with the first gradient and the second section with a second gradient based on the computer system operating in a second mode and the first setting in response to receiving a request enables the computer system to automatically identify the current mode in which the computer system is operating and a value of a current setting, thereby providing improved visual feedback to the user and performing an operation when a set of conditions has been met without requiring further user input.

In some embodiments, the indication of the current selected value for the setting (e.g., 890) is displayed at the first position. In some embodiments, while displaying the indication of the current selected value for the setting (e.g., 890) at the first position, the computer system detects a request (e.g., 805b) to move the indication of the current selected value for the setting from the first position to a second position relative to the representation of the control (e.g., 806), wherein the second position is at a position that is closer to a position corresponding to a maximum value for the setting than the first position. In some embodiments, in response to detecting the request to move the indication of the current selected value for the setting (e.g., 890) from the first position to the second position: the computer system displays, via the display generation component, the indication of the current selected value (e.g., 890) for the setting at the second position. In some embodiments, while displaying the indication of the current selected value (e.g., 890) for the setting at the second position and in accordance with a determination that the computer system (e.g., 600) is operating in the first mode (e.g., 808c) for the first setting while the indication of the current selected value (e.g., 890) for the setting is displayed at the second position, the computer system displays, via the display generation component, the first section of the representation of the control (e.g., 806a) with the first gradient (e.g., circles in 806a) and a third section of the representation of the control with a third gradient different from the first gradient. In some embodiments, the first section and the second section are displayed with the first gradient in accordance with a determination that the computer system is operating in the first mode for the first setting while the indication of the current selected value for the setting is displayed at the second position. In some embodiments, in accordance with a determination that the computer system (e.g., 600) is operating in the first mode (e.g., 808c) for the first setting while the indication of the current selected value for the setting (e.g., 890) is displayed at the second position, the computer system displays, via the display generation component, the first section of the representation of the control (e.g., 806a) and the third section of the representation of the control with the first gradient (e.g., circles in 806a). In some embodiments, the first section, the second section, and the third section are displayed with the first gradient in accordance with a determination that the computer system is operating in the first mode for the first setting while the indication of the current selected value for the setting is displayed at the second position. Displaying a first section of a representation of a control with a first gradient and a second section of the representation of the control with a second gradient based on the computer system operating in a first mode while the indication of a current selected value of the setting is displayed at a second position closer to a maximum value than a first position or displaying a first section of a control and the second section of the control with the first gradient based on the computer system operating in first mode while the indication of the current selected value for the setting is displayed at the second position enables a computer system to automatically notify a user of the mode in which the computer system, thereby providing improved visual feedback to the user and performing an operation when a set of conditions has been met without requiring further user input.

In some embodiments, displaying the third section of the representation of the control (e.g., 806) with the third gradient (e.g., 892a) includes masking a first user interface object with one or more portions of the third section of the representation of the control. In some embodiments, masking the first user interface object onto the representation of the control includes masking the first user interface object with at least a portion of the first gradient and/or the second gradient. In some embodiments, the first user interface object does not include a color in and/or does not resemble the first gradient and/or the second gradient. In some embodiments, a mode is a heating mode, a cooling mode, and/or a combination mode (e.g., an in-between mode and/or a heating and cooling mode). Displaying a section of the representation of a control with a gradient including masking a user interface object with a portion of the section of the representation of the control with the gradient enables the computer system to automatically notify a user of a mode in which the computer system operating and a current selected value for the setting, thereby providing improved visual feedback to the user and performing an operation when a set of conditions has been met without requiring further user input.

In some embodiments, displaying the third section of the representation of the control (e.g., 806) with the first gradient (e.g., circles in 806a) does not include masking the first user interface object (and/or any user interface object on and/or with the representation of the control) with one or more portions of the third section of the representation of the control.

In some embodiments, while displaying the indication of the current selected value for the setting (e.g., 890) at the second position and displaying the first user interface object, the computer system detects a request (e.g., 806b) (e.g., via one or more inputs directed to a control, such as a tap input, a gaze input, a swipe input, a selection input, a mouse click, and/or an air input (e.g., a pointing input, an air tap input, and/or a hand clenching input)) to move the indication of the current selected value for the setting from the second position to a third position relative to the representation of the control (e.g., 806), wherein the third position is at a position that is closer to the position corresponding to the maximum value for the setting than the second position. In some embodiments, in response to detecting the request to move the indication of the current selected value for the setting (e.g., 890) from the second position to the third position: the computer system moves the indication of the current selected value for the setting (e.g., 890) to the third position. In some embodiments, the computer system changes a visual appearance of the first user interface object from a first visual appearance to a second visual appearance that is darker than the first visual appearance. In some embodiments, the first user interface (e.g., a masked object and/or an objected used for masking) gets darker and/or less transparent as the indication of the current selected value is moved further away from the minimum value. Moving an indication of a current selected value and changing a visual appearance of a user interface object to a darker visual appearance in response to detecting a request to move the indication of the current selected value for a setting from the second position to the third position that is closer to a maximum value than the second position enables the computer system to notify a user of a mode in which the computer system operating and the current selected value for the setting, thereby providing improved visual feedback to the user and performing an operation when a set of conditions has been met without requiring further user input.

In some embodiments, while displaying the indication of the current selected value for the setting (e.g., 890) at the second position and displaying the first user interface object, the computer system detects a request (e.g., 805c) (e.g., via one or more inputs directed to a control, such as a tap input, a gaze input, a swipe input, a selection input, a mouse click, and/or an air input (e.g., a pointing input, an air tap input, and/or a hand clenching input)) to move the indication of the current selected value for the setting from the second position to a fourth position relative to the representation of the control (e.g., 806), wherein the fourth position is at a position that is further away from the position corresponding to the maximum value for the setting than the second position. In some embodiments, in response to detecting the request to move the indication of the current selected value for the setting (e.g., 890) from the second position to the fourth position: the computer system moves the indication of the current selected value for the setting (e.g., 890) to the fourth position. In some embodiments, the computer system changes a visual appearance of the first user interface object from a third visual appearance to a fourth visual appearance that is lighter (e.g., less bright, more translucent, and/or a color determined to be lighter) than the third visual appearance. In some embodiments, the fourth visual appearance is lighter than the second visual appearance. In some embodiments, the first visual appearance is the same as the third visual appearance. In some embodiments, the first user interface (e.g., a masked object and/or an objected used for masking) gets lighter and/or more transparent as the indication of the current selected value is moved further away from the minimum value. Moving an indication of a current selected value for a setting of second position and changing a visual appearance of a virtual object to a lighter appearance in response to detecting a request to move the indication of the current selected from a first position to a second position enables the computer system to notify a user of a mode the computer system in operating at and the current selected value for the setting, thereby providing improved visual feedback to the user and performing additional control options without cluttering the UI.

In some embodiments, the first mode (e.g., 808c) is a cooling mode. Displaying a first section of a representation of a control and a second section of the representation of the control with a first gradient expanding across the first section and the second section based on the computer system operating in a first mode (e.g., a cooling mode) and a first setting or displaying the first section with the first gradient and the second section with a second gradient based on the computer system operating in a second mode and the first setting in response to receiving a request enables the computer system to automatically identify the current mode in which the computer system is operating and a value of a current setting, thereby providing improved visual feedback to the user and performing an operation when a set of conditions has been met without requiring further user input.

In some embodiments, the second mode (e.g., 808b) is a heating mode. Displaying a first section of a representation of a control and a second section of the representation of the control with a first gradient expanding across the first section and the second section based on the computer system operating in a first mode and a first setting or displaying the first section with the first gradient and the second section with a second gradient based on the computer system operating in a second mode (e.g., a heating mode) and the first setting in response to receiving a request enables the computer system to automatically identify the current mode in which the computer system is operating and a value of a current setting, thereby providing improved visual feedback to the user and performing an operation when a set of conditions has been met without requiring further user input.

In some embodiments, the first section of the representation of the control (e.g., 806a) starts from a position corresponding to a minimum value for the setting and ends at a position corresponding to a first value for the setting. In some embodiments, the second section of the representation of the control (e.g., 806b) starts from the position corresponding to the first value for the setting and to at least (and, in some embodiments, ends at) a position corresponding to the current selected value for the setting. Having the first section of a representation of a control starting from position corresponding to a minimum value and ending at a position corresponding to a first value for a setting and a second section of the representation of the control starting from the position corresponding to the first value for the setting and goes to at least a position corresponding to a current selected value for the setting enables the computer system to focus the attention of the user to the current selected value for the setting and the first value for the setting, thereby providing improved visual feedback to the user and reducing a number of inputs need to perform an operation.

In some embodiments, the first section of the representation of the control (e.g., 806a) and the second section of the representation of the control (e.g., 806b) do not include a set of one or more representations (e.g., tick marks, dots, value marks, and/or user interface elements indicating one or more values) of values (and/or any representations of values). In some embodiments, a fourth section of the representation of the control includes the set of one or more representations of values. Having a first section of a representation of a control and a second section of the representation of the control that do not include a set of one or more representations and a fourth section of the representation of the control that includes the set of one or more representations enables a computer system to focus the attention of the user to an area in which a current selected value for the setting is located on the representation of the control, thereby providing improved visual feedback to the user and reducing a number of inputs needed to perform an operation.

In some embodiments, the first section of the representation of the control (e.g., 806a) and the second section of the representation of the control (e.g., 806b) is on a first side of the indication of the current selected value for the setting (e.g., 890). In some embodiments, one or more sections (and/or most and/or all sections) on the second side of the indication of the current selected value for the setting does not include a gradient. In some embodiments, the first side is different from the second side. In some embodiments, no other gradient is on the second side of the indication of the current selected value. Having the first section of the representation of a control and the second section of the representation of the control be on a first side of an indication of the current selected value for the setting and one or more sections on the second side of the indication of the current selected value for the setting not including a gradient enables the computer system to focus the attention of the user to an area on the representation of a control where the current selected value is positioned, thereby providing improved visual feedback to the user and reducing a number of inputs needed to perform an operation.

In some embodiments, the first gradient (e.g., circles in 806a) is a gradient of (e.g., including, consisting, and/or consisting essentially of) a first primary color. In some embodiments, the second gradient (e.g., circles in 806b) is a gradient of a second primary color different from the first primary color. Having a first gradient be a gradient of first primary color and a second gradient be a gradient of second primary color enables the computer system to notify the user of a first section and second section of a representation of a control, thereby providing improved visual feedback to the user and reducing the number of inputs needed to perform an operation.

In some embodiments, the first gradient (e.g., circles shown in 806a) is a gradient of a first set of one or more primary colors, secondary colors, or any combination thereof. In some embodiments, the second gradient (e.g., circles shown in 806b) is a gradient of a second set of one or more primary colors, secondary colors, or any combination thereof. In some embodiments, the first set of one or more primary colors, secondary colors, or any combination thereof is different from the second set of one or more primary colors, secondary colors, or any combination thereof. Having the first gradient be a gradient of a first set of one or more primary colors, secondary colors, or any combination thereof and the second gradient be a second set of one or more primary colors, secondary colors, or any combination thereof enables the computer system to distinguish different sections of a representation of a control for a user, thereby providing improved visual feedback to the user and reducing the number of inputs needed to perform an operation.

In some embodiments, the second gradient (e.g., circles in 806b) is not a continuation of the first gradient (e.g., circles in 806a). In some embodiments, the first gradient is not a continuation of the second gradient. Having a second gradient not be continuous with a first gradient enables a computer system to distinguish different sections of a representation of a control for a user, thereby providing improved visual feedback to the user and reducing the number of inputs needed to perform an operation

In some embodiments, the computer system displays the second section of the representation of the control (e.g., 806b) with the second gradient (e.g., circles in 806b) includes masking a second user interface object with one or more portions of the second section of the representation of the control. In some embodiments, masking the first user interface object onto the representation of the control includes masking the second user interface object with at least a portion of the first gradient and/or the third gradient. In some embodiments, the first user interface object does not include a color in and/or does not resemble the first gradient and/or the third gradient. In some embodiments, the second user interface object resembles a section of the control that corresponds to the maximum value for the setting (e.g., red and/or pink) more than the second user interface object resembles the section of the control that corresponds to a minimum value for the setting (e.g., blue and/or purple). In some embodiments, the first user interface object resembles a section of the control that corresponds to the minimum value for the setting (e.g., blue and/or purple) more than the first user interface object resembles the section of the control that corresponds to a maximum value for the setting (e.g., red and/or pink). In some embodiments, the first user interface object has a different hue than the second user interface. In some embodiments, the first user interface object is a different primary color than the second user interface object. Displaying a second section of a representation of the control with a second gradient that includes masking a second user interface object with a one or more portions of the second section of the representations of the control enables the computer system to notify a user of a mode of operation of the computer system, thereby providing improved visual feedback to the user, reducing the number of inputs needed to perform an operation, and performing an operation when a set of conditions has been met without requiring further user input.

In some embodiments, displaying the second section of the representation of the control (e.g., 806b) with the first gradient (e.g., circles shown in 806a) does not include masking the second user interface object (or, in some embodiments, any user interface object on the representation of the control) with one or more portions of the second section of the representation of the control. In some embodiments, displaying the first section of the representation of the control (e.g., 806a) does not include masking a third user interface object (e.g., and/or on and/or with the representation of the control) with the first section of the representation of the control.

In some embodiments, in response to receiving the request and in accordance with a determination that the computer system (e.g., 600) is operating in a third mode (e.g., an in-between temperature mode and/or a combination of the first mode and the second mode) for the first setting while the indication of the current selected value for the setting (e.g., 890) is displayed at a first position relative the representation of the control (e.g., 806), wherein the third mode is different from the first mode (e.g., 808c), the computer system displays, via the display generation component, the first section of the representation of the control (e.g., 806a) with the first gradient (e.g., circles shown in 806a) while displaying the second section of the representation of the control (e.g., 806b) with a fourth gradient and displaying a fourth section of the representation of the control with a fifth gradient, wherein the fourth gradient is different from the fifth gradient. In some embodiments, the fifth gradient has a different set of hues than the fourth gradient. Displaying a first section of a representation of a control with a first gradient while displaying a second section of the representation of the control with a fourth gradient and displaying a fourth section of the representation of the control with a fifth gradient in response to receiving a request and based on the computer system operating in a third mode for a first setting enables a computer system to automatically notify a user that the computer system is operating in a third mode, thereby providing improved visual feedback to the user, reducing the number of inputs needed to perform an operation, and performing an operation when a set of conditions has been met without requiring further user input.

In some embodiments, in accordance with a determination that the computer system (e.g., 600) is a fourth mode (e.g., a combination of the first mode and the second mode and/or an in-between temperature mode) that is different from the first mode (e.g., 808c) and the second mode (e.g., 808b): the computer system concurrently displaying, via the display generation component, a second indication of a second current selected value for the setting that is different from the indication of the current selected value for the setting (e.g., 890). In some embodiments, the computer system concurrently displaying, via the display generation component, a third set of one or more hues relative to (and/or underneath) the indication of the current selected value for the setting (e.g., 890) and a fourth set of one or more hues relative to (and/or underneath) the second indication of the second current selected value for the setting, wherein the third set of one or more hues is different from the fourth set of one or more hues. In some embodiments, the fourth set of hues is not displayed relative to the indication of the current selected value while the third set of hues is displayed relative to the indication of the current selected value for the setting. In some embodiments, the third set of hues is not displayed relative to the third indication of the second current selected value for the setting while the fourth set of hues is displayed relative to the third indication of the second current selected value for the setting. Displaying, concurrently, a third set of one or more hues relative to the indication of the current selected value for the setting and a fourth set of one or more hues relative to the second indication of the second current selected value for the setting based on a determination that the computer system is in the third mode enables the computer system to display current selected values to the user and enables the computer system to automatically notify a user that the computer system is operating in a third mode, thereby providing improved visual feedback to the user, reducing the number of inputs needed to perform an operation, and performing an operation when a set of conditions has been met without requiring further user input.

In some embodiments, while the computer system (e.g., 600) is in the first mode (e.g., 808c) or the second mode (e.g., 808b), the computer system displays less indications of current selected values than while the computer system is operating in the fourth mode. Displaying less indications of current selected values while the computer system is operating in a first mode or a second mode than the number of indications that are displayed while the computer system is operating in a third mode enables the computer system to notify the user when the computer system is operating in a third mode (or the first mode or second mode), thereby providing improved visual feedback to the user and reducing the number of inputs needed to perform an operation.

In some embodiments, before receiving the request, the computer system displays, via the display generation component, a user interface that includes a first control in a plurality of controls (e.g., 610a-610f). In some embodiments, while displaying the user interface that includes the first control in the plurality of controls, the computer system detects an input (e.g., 605a) (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the first control in the plurality of controls. In some embodiments, in response to detecting the input directed to the first control in the plurality of controls, the computer system displays, via the display generation component, an animation that includes expanding (e.g., 612b in FIGS. 6A and 612b in FIG. 6B) (e.g., gradually expanding and/or increasing the size of) the first control in the plurality of control into a second user interface (e.g., 614) that includes a third indication of a third current selected value, and wherein the user interface that includes the indication of the current selected value for a setting and the representation of the control for the setting is displayed in response to detecting an input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to the second user interface. Displaying an animation that shows the first control expanding into a second user interface that includes a third indication of third current selected value for a setting in response to detecting an input directed the first control in the plurality of controls enables the computer system to notify a user of the detected input and the impact that the detected input has on the first control, thereby providing improved visual feedback to the user and reducing the number of inputs needed to perform an operation.

In some embodiments, the second user interface (e.g., 614) is overlaid on (e.g., overlaid on, on top of, adjacent to, and/or hovering over) the user interface that includes the plurality of controls. In some embodiments, the second user interface is translucent. In some embodiments, the user interface that includes the plurality of controls is not translucent. In some embodiments, the second user interface is more translucent than the user interface that includes the plurality of controls. Displaying the second user interface overlaid on the first user interface allows the user to view at least some of the plurality of controls while the second user interface is displayed, thereby providing improved visual feedback to the user and reducing the number of inputs needed to perform an operation.

In some embodiments, computer system 600 displays a representation of a control with a single gradient or multiple gradients based on the capabilities and/or functions of the corresponding external devices. In some embodiments, when the computer system 600 is connected to a heater, the representation of control for the heater will be a single gradient, since the heater only has a heating function, and this function can be represented using a single gradient. In some embodiments when computer system 600 is connected to a device like heating and cooling system the representation of control for the heating and cooling system will have multiple gradients, since the heating and cooling system has multiple functions and must be represented through separate gradients.

FIGS. 8A-8J illustrate an exemplary scenario, where an interface of computer system allows a user to select and set a temperature value for an external device (e.g., a thermostat and/or a HVAC unit). Amongst other things, FIGS. 8A-8J describes techniques for displaying user interfaces that reduce visual distractions and/or reduces confusion for the user. In some embodiments, a computer system displays one or more of the user interfaces using a masked object that is presented on a control (e.g., a temperature control, a scale, and/or another type of control or scale) in order to provide the user with feedback that the user is setting a particular type of setting (e.g., heating setting, cooling setting, and/or in between setting) while using the computer system. In some embodiments, the masked object is displayed adjacent to a grabber used to set the temperature value for the external device. In some embodiments, the techniques described below apply to other external devices besides thermostats, such as smart lights, smart bulbs, and/or smart plugs. In some embodiments, the user interfaces described below are presented on a display of the external device. In some embodiments, computer system 600 changes the color of the masked object and/or uses a different masked object based on the mode at which the computer system 600.

FIG. 8A illustrates computer system 600 displaying home user interface 602, which includes thermostat control 610b. In some embodiments, computer system 600 displays home user interface 602 using one or more techniques described above in relation to FIG. 6A. At FIG. 8A, computer system 600 detects tap input 805a directed to thermostat control 610b.

As illustrated in FIG. 8B, in response to detecting tap input 805a, computer system 600 displays temperature selection control interface 800. Temperature selection control interface 800 includes current detected temperature 802, environment indicator 804, temperature control 806, and thermostat operating mode controls 808. Current detected temperature 802 indicates that the current detected temperature in an environment (e.g., an environment detected by a thermostat and/or HVAC system corresponding to thermostat control 610b of FIG. 8A) is 68 degrees. Environment indicator 804 indicates a detected humidity in the environment is 35 percent. In some embodiments, environment indicator 804 includes and/or indicates other detected environmental measurements, such as air quality and/or dew point. In some embodiments, computer system 600 displays different environmental measurements indicated by environment indicator 804 concurrently. In some embodiments, in response to detecting one or more inputs directed to environment indicator 804, computer system 600 displays different environmental measurements other than the detected humidity in the environment.

As illustrated in FIG. 8B, temperature selection control interface 800 includes temperature control 806. Temperature control 806 represents temperature values that increase from left to right along temperature control 806 (e.g., from 0 degrees Fahrenheit to 120 degrees Fahrenheit, from 10 degrees Celsius to 40 degrees Celsius, and/or from 0 degrees Kelvin to 300 degrees Kelvin). As illustrated in FIG. 8B, first range of temperatures 806a extends in a clockwise direction from a minimum temperature value of the range of temperatures (e.g., far left of temperature control 806) represented by temperature control 806 to a median and/or in-between temperature value represented by temperature control 806. Moreover, second range of temperatures 806b extends in a counterclockwise direction from a maximum temperature value of the range of temperatures (e.g., far right of temperature control 806) represented by temperature control 806 to the median and/or in-between temperature value represented by temperature control 806. At FIG. 8B, the triangles illustrated inside the perimeter of temperature control 806 represent a first gradient (e.g., more triangles represent a different color characteristic of the first gradient than less triangles), and the diamonds inside of the perimeter of temperature control 806 represent a second gradient (e.g., more diamonds represent a different color characteristic of the second gradient than less diamonds). At FIG. 8B, computer system 600 displays the first gradient along first range of temperatures 806a and displays the second gradient along second range of temperatures 806b. The first gradient corresponds to cooler temperatures while the second gradient corresponds to warmers temperatures. Likewise, the temperature values in first range of temperatures 806a correspond to cooler temperature values than the temperature values in the second range of temperatures 806b. At FIG. 8B, the first gradient is an indication of cooling, a cooling mode, and/or cooler temperatures (e.g., the more triangles and/or the greater density of the triangles within an area, the cooler the temperature) while the second gradient is an indication of warming, a heating mode, and/or warmer temperatures (e.g., the more diamonds and/or the greater density of the diamonds within an area, the warmer the temperature). In some embodiments, the first gradient uses a different set of colors than the second gradient. In some embodiments, by using the different sets of colors, computer system 600 can indicate cooling and/or warming differently. In some embodiments, the first gradient includes colors that have a cool temperature, such as blue and/or violent. In some embodiments, the second gradient includes colors that have a warm temperature, such as pink and/or red. In some embodiments, first range of temperatures 806a and/or second range of temperatures 806b are different sizes and/or cover different sections of temperature control 806 than the sizes and/or the sections illustrated in FIG. 8B. In some embodiments, the gradients included in temperature control 806 corresponds to the type of device (e.g., HVAC, heater, refrigerator, and/or freezer) connected to computer system 600. In some embodiments, only the first gradient is displayed from the minimum to maximum value of temperature control 806 for some types of external devices (e.g., an air conditioner that is not able to warm). In some embodiments, only the second gradient is displayed from the minimum to maximum value of temperature control 806 for other types of devices (e.g., a heater that is not able to cool).

As illustrated in FIG. 8B, computer system 600 is displaying current temperature setting grabber 890 near the maximum temperature value of temperature control 806. Notably, the second gradient covers second range of temperatures 806b up until (e.g., extending in a clockwise direction towards the maximum temperature value) current temperature setting grabber 890 and not after (e.g., between current temperature setting grabber 890 and the maximum temperature value) the current temperature setting grabber 890. As illustrated in FIG. 8B, computer system 600 displays current detected temperature indicator 806c near the center of the temperature control 806, where current detected temperature indicator 806c is represented by a tick mark that is positioned on temperature control 806 at a value corresponding to the current temperature of 68 degrees.

As illustrated in FIG. 8B, as a part of displaying temperature selection control interface 800, computer system 600 displays thermostat operating mode controls 808. Thermostat operating mode controls 808 includes off mode control 808a, heating mode control 808b, cooling mode control 808c, and in between mode control 808d. At FIG. 8B, computer system 600 is causing a thermostat and/or HVAC system to operate in the heating mode, which is indicated by heating mode control 808b being bolded in FIG. 8B. In some embodiments, in response to detecting an input directed to off mode control 808a, computer system 600 causes a thermostat and/or an HVAC system to turn off. In some embodiments, in response to detecting an input directed to heating mode control 808b, computer system 600 causes a thermostat and/or an HVAC system to operate in a heating mode, where the thermostat and/or HVAC system warms an environment. In some embodiments, in response to detecting an input directed to cooling mode control 808c, computer system 600 causes a thermostat and/or an HVAC system to operate in a cooling mode, where the thermostat and/or HVAC system cools an environment. In some embodiments, in response to detecting an input directed to in between mode control 808d, computer system 600 causes a thermostat and/or an HVAC system to operate in an in between mode, where the thermostat and/or HVAC system attempts to keep the temperature of the environment in between two different temperatures. At FIG. 8B, computer system 600 detects counterclockwise swipe input 805b directed to temperature setting grabber 890 while operating in the heating mode.

As illustrated in FIG. 8C, in response to detecting counterclockwise swipe input 805b, computer system 600 moves temperature setting grabber 890 from a temperature value in second range of temperatures 806b to a temperature value in first range of temperature 806a. At FIG. 8C, computer system 600 replaces a portion of the first gradient in first range of temperatures 806a with a different gradient and/or color, which is represented by warm color indications 892b being illustrated in FIG. 8C. At FIG. 8C, computer system 600 replaces a portion of the first gradient in first range of temperatures 806a with a different gradient and/or color because computer system 600 (and/or an HVAC and/or thermostat) is operating in the heating mode and temperature setting grabber 890 is at a temperature value in first range of temperature 806a. As illustrated in FIG. 8C, warm color indications 892b are illustrated as filled in diamonds. Warm color indications 892b are indicated as filled in diamonds to indicate the section of temperature control 806 occupied by warm color indications 892b has a visual appearance that is closer to the second gradient (e.g., represented as unfilled diamonds in FIG. 8B) than the first gradient (e.g., represented as unfilled triangles in FIG. 8C). Computer system 600 displays the section of temperature control 806 occupied by warm color indications 892b to reduce confusion and/or visual distraction regarding the temperature value that corresponds to the position temperature setting grabber 890. While causing an HVAC and/or thermostat to operate in a heating mode, computer system 600 could confuse a user by giving an indication that the temperature value being set via temperature setting grabber 890 corresponds to a cool temperature. Ultimately, a user could misinterpret the indication that the temperature value being set via temperature setting grabber 890 corresponds to a cool temperature as indicating that the HVAC and/or thermostat is operating in the cooling mode instead of the heating mode. Thus, to avoid this confusion, computer system 600 modifies a section of the first gradient immediately before (and, in some embodiments, after) temperature setting grabber 890 to have a different gradient and/or color (which corresponds to the section of temperature control 806 occupied by warm color indications 892b illustrated in FIG. 8C). At FIG. 8C, computer system 600 modifies the section of the first gradient by masking a user interface object that is a different color and/or gradient than the section of the first gradient. In some embodiments, the different color includes a color of the second gradient and/or includes a lighter color than the one or more colors in the second gradient. In some embodiments, at FIG. 8C, the section of temperature control 806 occupied by warm color indications 892b has the same visual appearance as one or more portions of the section of temperature control 806 occupied by the second gradient illustrated in FIG. 8B. In some embodiments, at FIG. 8C, the section of temperature control 806 occupied by warm color indications 892b has a similar color temperature as the second gradient. In some embodiments, at FIG. 8C, the section of temperature control 806 occupied by warm color indications 892b is orange and the second gradient is red (e.g., different variations of red). At FIG. 8C, computer system 600 detects clockwise swipe input 805c directed to temperature setting grabber 890 while operating in the heating mode.

As illustrated in FIG. 8D, in response to detecting clockwise swipe input 805c, computer system 600 moves temperature setting grabber 890 from the temperature value in first range of temperatures 806a to a temperature value in second range of temperature 806b. At FIG. 8D, because computer system 600 (and/or an HVAC and/or thermostat) is operating in the heating mode and temperature setting grabber 890 is at a temperature value in second range of temperature 806b, computer system 600 visually shows that a portion of the second gradient in second range of temperatures 806b is replaced with a different gradient (e.g., portion that is immediately before (and, in some embodiments, after the temperature setting grabber 890)), even when computer system 600 uses a masked object while operating in the particular mode (e.g., heating mode). In some embodiments, computer system 600 continues to apply a masked object; however, the masked object is less visually distinguishable from the second gradient, such that the masked object does not modify the appearance of the second gradient. In some embodiments, the computer system 600 does not replace a portion of the second gradient in first range of temperatures 806a with the different gradient because the second gradient corresponds to the heating mode, so visual distraction and/or confusion is reduced while displaying the second gradient by the temperature setting grabber 890 and operating in the heating mode. In some embodiments, one or more warm color indications and/or one or more cool color indications are illustrated in a section that would visually change and/or impact a portion of the gradient above a threshold amount (e.g., such as orange as compared to blue and not orange-red as compared to orange).

At FIG. 8D, a determination is made that the temperature value that corresponds to the position of temperature setting grabber 890 (e.g., “current set temperature”) is greater than the current detected temperature value (e.g., the temperature value that corresponds to current detected temperature indicator 806c). As illustrated in FIG. 8D, because this determination is made while operating in the heating mode, computer system 600 displays work indications 814 between current detected temperature indicator 806c and temperature setting grabber 890. In FIG. 8D, work indications 814 are illustrated as filled in circles. Work indications 814 indicate that work has to be done (e.g., by a HVAC system and/or heating pump system) in order to heat an environment from the current detected temperature (68 degrees) to current set temperature. Looking back at FIG. 8C, computer system 600 does not display any work indications because the current set temperature of FIG. 8C was less than the current detected temperature of FIG. 8C while operating in the heating mode. Thus, at FIG. 8C, there is no work needed to be done to heat the current detected temperature to the current set temperature because the current set temperature is lower than the current detected temperature. In other words, the environment would need to be cooled and not heated for the current detected temperature to be the current set temperature in the environment. Thus, there is no work for a heating system in heating mode to perform at FIG. 8C. Moreover, in FIGS. 8C-8D, the computer system 600 does not display a gradient past the position of temperature setting grabber 890 (e.g., from temperature setting grabber 890 to a maximum temperature value of temperature control 806). As illustrated in FIG. 8C-8D, computer system 600 increases the amount of temperature control 806 that does not have the first gradient and the second gradient as temperature setting grabber 890 is moved toward the minimum value of temperature control 806 and decreases the amount of temperature control 806 that does not have the first gradient and the second gradient as temperature setting grabber 890 is moved away from the minimum value of temperature control 806. In some embodiments, a determination is made that a current set temperature is less than the current detected temperature of FIG. 8C while a heating system is operating in the heating mode, computer system 600 displays an out-of-range indication (e.g., 812). In some embodiments, a determination is made that a current set temperature is more than the current detected temperature of FIG. 8C while cooling system is operating in the cooling mode, computer system displays an out-of-range indication (e.g., 810). At FIG. 8D, computer system 600 detects tap input 805d directed to cooling mode control 808c.

As illustrated in FIG. 8E, in response to detecting tap input 805d, computer system 600 transitions the thermostat (and/or HVAC system) from operating in the heating mode to operate in the cooling mode, which is indicated by cooling mode control 808c being bolded. At FIG. 8E, computer system 600 ceases to display work indications 814 between current detected temperature indicator 806c and temperature setting grabber 890 because a determination has been made that no work has to be done to cool the environment from the current detected temperature to the current set temperature. Here, the determination is made that no work has been done because the temperature value that corresponds to the position of temperature setting grabber 890 is greater than the current detected temperature value, so a system (e.g., HVAC system and/or heating pump system) cannot cool an environment in a manner that would allow the current detected temperature to reach the current set temperature (e.g., one would have to heat the environment instead).

Moreover, in response to detecting tap input 805d, computer system 600 replaces a portion of the second gradient in second range of temperatures 806b with a different gradient and/or color, which is represented by cool color indications 892a being illustrated in FIG. 8E. At FIG. 8E, computer system 600 replaces a portion of the second gradient in second range of temperatures 806b with a different gradient and/or color because computer system 600 (and/or an HVAC and/or thermostat) is operating in the cooling mode and temperature setting grabber 890 is at a temperature value in second range of temperature 806b. In FIG. 8E, cool color indications 892a are illustrated as filled in triangles. Cool color indications 892a are indicated as triangles to indicate that the section of temperature control 806 occupied by cool color indications 892a has a visual appearance that is closer to the first gradient than the second gradient (e.g., represented as unfilled diamonds in FIG. 8D). Computer system 600 displays the section of temperature control 806 occupied by cool color indications 892a to reduce confusion and/or visual distraction regarding the temperature value that corresponds to the position temperature setting grabber 890. While causing an HVAC and/or thermostat to operate in a cooling mode, computer system 600 could confuse a user by giving an indication that the temperature value being set via temperature setting grabber 890 corresponds to a warm temperature. Ultimately, a user could misinterpret the indication that the temperature value being set via temperature setting grabber 890 corresponds to a warm temperature as indicating that the HVAC and/or thermostat is operating in the heating mode instead of the cooling mode. Thus, to avoid this confusion, computer system 600 modifies a section of the second gradient immediately before (and, in some embodiments, after) temperature setting grabber 890 to have a different gradient and/or color (which corresponds to the section of temperature control 806 occupied by cool color indications 892a illustrated in FIG. 8E). At FIG. 8E, computer system 600 modifies the section of the second gradient by masking a user interface object that is a different color and/or gradient than the section of the second gradient. In some embodiments, the different color includes a color of the first gradient and/or includes a darker color than the one or more colors in the first gradient. In some embodiments, at FIG. 8E, the section of temperature control 806 occupied by cool color indications 892a has the same visual appearance as one or more portions of the section of temperature control 806 occupied by the first gradient. In some embodiments, at FIG. 8E, the section of temperature control 806 occupied by cool color indications 892a has a similar color temperature as the second gradient. In some embodiments, at FIG. 8E, the section of temperature control 806 occupied by cool color indications 892a is violet and the first gradient is blue (e.g., different variations of blue). In some embodiments, the user interface object used to mask the second gradient at FIG. 8E is different from the user interface object used to mask the first gradient at FIG. 8C. In some embodiments, the user interface object used to mask the second gradient at FIG. 8E includes different primary and secondary colors and/or hues than the user interface object used to mask the first gradient at FIG. 8C. At FIG. 8E, computer system 600 detects counterclockwise swipe input 805e directed to temperature setting grabber 890 while operating in the cooling mode.

As illustrated in FIG. 8F, in response to detecting counterclockwise swipe input 805e, computer system 600 moves temperature setting grabber 890 from a temperature value in second range of temperatures 806b to a temperature value in first range of temperature 806a. At FIG. 8F, a determination is made that work has to be done to cool the environment from the current detected temperature to the current set temperature. Here, the determination is made that work has been done because the temperature value that corresponds to the position of temperature setting grabber 890 is lower than the current detected temperature value, so a system (e.g., HVAC system and/or heating pump system) can cool an environment in a manner that would allow the current detected temperature to reach the current set temperature (e.g., one would have to heat the environment instead). As illustrated in FIG. 8F, because the determination is made that work has to be done to cool the environment from the current detected temperature to the current set temperature, computer system 600 displays work indication 814. In addition, computer system 600 does not visually show that a portion of the first gradient is different in the area that is adjacent to the temperature grabber 890 because computer system 600 (and/or an HVAC and/or thermostat) is operating in the cooling mode and temperature setting grabber 890 is at a temperature value in first range of temperature 806a; thus, there is a reduced amount of distraction and/or confusion for one or more similar reasons as those described above in relation to FIG. 8D. In some embodiments, computer system 600 continues to apply a masked object; however, the masked object is less visually distinguishable from the first gradient, such that the masked object does not modify the appearance of the first gradient.

At FIG. 8F, computer system 600 has continued to detect counterclockwise swipe input 805e (and/or has not detected liftoff of counterclockwise swipe input 805e). As illustrated in FIG. 8F, computer system 600 updates environment indicator 804 to have a different value than the value of environment indicator at FIG. 8E. Environment indicator 804 of FIG. 8F has the current detected temperature of 68 degrees while environment indicator 804 of FIG. 8E had the current detected humidity. In some embodiments, at FIG. 8F, computer system 600 updates environment indicator 804 to the current detected temperature of 68 degrees because an input mechanism, such as a user hand or stylus, is likely to block and/or cover current detected temperature 802 while counterclockwise swipe input 805e is being made. In some embodiments, as counterclockwise swipe input 805e, environment indicator 804 is updated to include the current set temperature and/or another value. At FIG. 8F, computer system 600 detects a change in the current detected temperature, where the temperature in an environment has cooled by 1 degree.

As illustrated in FIG. 8G, computer system 600 updates current detected temperature 802 from 68 degrees to 67 degrees in response to detecting the change in the current detected temperature. Moreover, in response to detecting the change in the current detected temperature, computer system 600 moves current detected temperature indicator 806c to left towards temperature setting grabber 890 without requiring any user input. After moving current detected temperature indicator 806c, computer system 600 ceases to display one of work indication 814 that was previously displayed in FIG. 8F to indicate that less work is required by a system (e.g., HVAC and/or heat pump) to cool the environment to the current set temperature. At FIG. 8G, computer system 600 detects tap input 805g on the left side of temperature setting grabber 890 and/or left side of temperature selection control interface 800.

As illustrated in FIG. 8H, in response to detecting tap input 805g, computer system 600 moves temperature setting grabber 890 to the left by one position on temperature control 806 (e.g., closer to where tap input 805g was detected). In other words, in response to detecting tap input 805g, computer system 600 decreases the current set temperature value by 1. In some embodiments, in response to detecting tap input 805g, computer system 600 decreases the current set temperature value by another amount, such as 2, 3, 4, 5, and/or 10. At FIG. 8I, computer system 600 also increases the amount of work indications 814 between temperature setting grabber 890 and current detected temperature indicator 806c because more work has to be performed to change the current detected temperature. At FIG. 8H, computer system 600 detects tap input 805h on the right side of temperature setting grabber 890.

As illustrated in FIG. 8I, in response to detecting tap input 805h, computer system 600 moves temperature setting grabber 890 to the right by one position on temperature control 806 (e.g., closer to where tap input 805h was detected). In other words, in response to detecting tap input 805h, computer system 600 increases the current set temperature value by 1. In some embodiments, in response to detecting tap input 805h, computer system 600 increases the current set temperature value by another amount, such as 2, 3, 4, 5, and/or 10. At FIG. 8I, computer system 600 also reduces the amount work indications 814 between temperature setting grabber 890 and current detected temperature indicator 806c because less work has to be performed to change the current detected temperature.

FIG. 8J illustrates computer system 600 is operating in an in between mode as indicated by in between control 808d being bolded. While operating in the in between mode, computer system 600 causes a thermostat and/or an HVAC system to keep the temperature of the environment in between a minimum temperature and a maximum temperature. As illustrated in FIG. 8J, computer system 600 displays minimum temperature grabber 896a and maximum temperature grabber 896b while operating in the in between mode. At FIG. 8J, computer system 600 has positioned minimum temperature grabber 896a and maximum temperature grabber 896b to temperature values within first range of temperatures 806a and current detected temperature indicator 806c is less than the values set for minimum temperature grabber 896a and maximum temperature grabber 896b. In some embodiments, computer system 600 does not position minimum temperature grabber 896a and maximum temperature grabber 896b to be placed closer than a minimum distance from each other (e.g., closer than 1-5 temperature values (e.g., degrees of temperature) from each other).

At FIG. 8J, computer system 600 replaces a first portion of the first gradient in first range of temperatures 806a with a different gradient (e.g., portion that is immediately before (and, in some embodiments, after) maximum temperature grabber 896b). Here, computer system 600 replaces a first portion of the first gradient because the first gradient corresponds to the cooling mode (e.g., illustrated with respect to warm color indications 892b), so visual distraction and/or confusion is reduced while displaying the first gradient by maximum temperature grabber 896a and by maximum temperature grabber 896b. Thus, computer system 600 can inform a user that maximum temperature grabber 896b corresponds to computer system 600 potentially causing the operation of a heating element (not a cooling element) to be modified based on the position of maximum temperature grabber 896b.

At FIG. 8J, a determination is made that the temperature value that corresponds to the position of minimum temperature grabber 896a is greater than the current detected temperature value (e.g., the temperature value that corresponds to current detected temperature indicator 806c). As illustrated in FIG. 8J, because this determination is made while operating in the in between mode, computer system 600 displays work indications 814 between current detected temperature indicator 806c and minimum temperature grabber 896a. Work indications 814 indicate that work has to be done (e.g., by a HVAC system and/or heating pump system) in order to heat an environment from the current detected temperature (e.g., 58 degrees) to current minimum temperature and/or maximum temperature. In some embodiments, work indications 814 are displayed from current detected temperature indicator 806c to maximum temperature grabber 896b.

Note that details of the processes described above with respect to method 900 (e.g., FIG. 9) are also applicable in an analogous manner to other methods described herein. For example, method 1000 optionally includes one or more of the characteristics of the various methods described above with reference to method 900. For example, one or more steps of method 1000 of displaying a control indicating work performed by an external device can be performed while managing a control for operating various modes of an external device using one or more steps of method 900. For brevity, these details are not repeated below.

FIG. 10 is a flow diagram illustrating a method (e.g., method 1000) for managing a control indicating work performed by an external device in accordance with some examples. Some operations in method 1000 are, optionally, combined, the orders of some operations are, optionally, changed, and some operations are, optionally, omitted.

As described below, method 1000 provides an intuitive way for managing a control indicating work performed by an external device. Method 1000 reduces the cognitive burden on a user for managing a control indicating work performed by an external device, thereby creating a more efficient human-machine interface. For battery-operated computing devices, enabling a user to manage a control indicating work performed by an external device faster and more efficiently conserves power and increases the time between battery charges.

In some embodiments, method 1000 is performed at a computer system (e.g., 600) that is in communication with a display generation component (e.g., a display, a touch-sensitive display, a projector, a light, and/or a set of one or more light emitting diodes) and one or more input devices. In some embodiments, the computer system is a phone, a watch, a tablet, a fitness tracking device, a wearable device, a television, a multi-media device, an accessory, a speaker, a head-mounted display (HMD), and/or a personal computing device. In some embodiments, the computer system is in communication with input/output devices, such as one or more cameras, speakers, microphones, sensors (e.g., heart rate sensor, monitors, antennas (e.g., using Bluetooth and/or Wi-Fi), and/or near-field communication sensors).

At 1002, the computer system displays, via the display generation component, a user interface (e.g., 800) that includes (at 1004) an indication of a current selected environmental value (e.g., 890) (e.g., desired temperature, sound, heat, air conditioning, openness, closeness, brightness, and/or dimness setting) for a setting (e.g., a temperature setting, a door setting, a light setting, and/or a sound setting) of a device (e.g., the computer system and/or another computer system in communication with the computer system).

At 1002, the computer system displays, via the display generation component, the user interface that includes (at 1006) an indication of a current detected environmental value (e.g., the current temperature of a room, the current level of ambient sound, the current heat, the current coolness, and/or the current fan output) for the setting of the device (e.g., 802).

At 1002, the computer system displays, via the display generation component, the user interface that includes (at 1008) a first set of one or more indications (e.g., 814 in FIG. 8D) at a first set of one or more positions between the indication of the current selected environmental value (e.g., 890) for the setting and the indication of the current detected environmental value for the setting of the device (e.g., 802).

At 1010, while displaying the first set of one or more indications (e.g., 814 in FIG. 8D) at the first set of one or more positions, the computer system detects, via the one or more input devices, an input (e.g., 806b) (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) corresponding to a request to change the current selected environmental value for the setting (and/or, in some embodiments, an input directed to the indication of the current selected environmental value for the setting).

At 1012, in response to detecting the input corresponding to the request to change the current selected environmental value for the setting in response to detecting the input corresponding to the request to change the current selected environmental value for the setting:

At 1012, in response to detecting the input corresponding to the request to change the current selected environmental value for the setting in response to detecting the input corresponding to the request to change the current selected environmental value for the setting: (at 1014) the computer system moves display of the indication of the current selected environmental value (e.g., 890) from a first position to a second position (e.g., on the user interface and/or on a representation of a scale (e.g., as described above in relation to method 900)). In some embodiments, the current selected environmental value has moved further away from the indication of the current detected environmental value for the setting of the device when the current selected environmental value is at the second position. In some embodiments, the indication of the current detected environmental value does not move in response to detecting an input directed to the indication of the current detected environmental and/or the input directed to the indication of the current selected environmental value for the setting.

At 1012, in response to detecting the input corresponding to the request to change the current selected environmental value for the setting in response to detecting the input corresponding to the request to change the current selected environmental value for the setting: (at 1016) the computer system displays, via the display generation component, a second set of one or more indications (e.g., 814 in FIG. 8F) at a second set of one or more positions between the indication of the current selected environmental value for the setting (e.g., 890) and the indication of the current detected environmental value for the setting of the device (e.g., 802), wherein at least one indication in the second set of one or more indications was not previously displayed before the input directed to the indication of a current selected environmental value for the setting was detected. In some embodiments, the first set of one or more indications is a set of indications of work that a device would have to perform in order for the current detected environmental value to reach the current selected environmental value. In some embodiments, the indication of the current selected environmental value is visually different from and/or represented with a different looking user interface object than the current detected environmental value. In some embodiments, the computer system receives a request (e.g., via one or more inputs directed to a control, such as a tap input, a gaze input, a swipe input, a selection input, a mouse click, and/or an air input (e.g., a pointing input, an air tap input, and/or a hand clenching input)). In some embodiments, in response to receiving the request, the computer system displays the user interface that includes the indication of the current selected environmental value for the setting of the device, the indication of the current detected environmental value for the setting of the device, and the first set of one or more indications. Displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected, response to detecting the input corresponding to the request to change the current selected environmental value for the setting provides the user with control over the computer system to display a new setting and allows the computer system to notify the user of how an input impacts the value along with the environment, thereby providing improved visual feedback to the user and reducing the number of inputs needed to perform an operation.

In some embodiments, the first set of one or more indications (e.g., 814 in FIG. 8D) at the first set of one or more positions is displayed in a first area (e.g., as described above in relation to method 900) of the user interface having a length that corresponds to a difference between the current selected environmental value at the first position and the current detected environmental value (e.g., 802). In some embodiments, the second set of one or more indications (e.g., 814 in FIG. 8F) at the second set of one or more positions is displayed in a second area (e.g., as described above in relation to method 900) of the user interface having a length that corresponds to a difference between the current selected environmental value for the setting at the second position and the current detected environmental value (e.g., 802). In some embodiments, the first set of one or more indications, the second set of one or more indications, the indication of the current selected environmental value, and/or the indication of the current detected environmental value are displayed on a scale. Displaying the first set of one or more indications with a length that corresponds to a difference between a current selected environmental value at a first position and current detected environmental and displaying the second set of one or more indications with a length that corresponds to a difference between the current selected environmental value at a second position and the current detected environmental value enables the computer system to notify the user of difference between the a newly selected environmental value and the detected environmental value, thereby providing improved visual feedback to the user and reducing the number of inputs needed to perform an operation.

In some embodiments, the current selected environmental value (e.g., 890) is a first temperature value, and the current detected environmental value (e.g., 802) is a second temperature value. In some embodiments, the first temperature value is different from the second temperature value. Displaying a current selected environmental value which is a first temperature and displaying a current detected environmental value which is a second temperature, enables the computer system to notify the user of the current temperature and the set temperature and thereby providing improved visual feedback to the user and reducing the number of inputs needed to perform an operation.

In some embodiments, the user interface includes a first content (e.g., 804 in FIG. 8F) (e.g., of a first type and/or corresponding to a first sensor value and/or a first type of sensor value) in a third area of the user interface. In some embodiments, while displaying the user interface that includes the first content in the third area, the computer system detects, via the one or more input devices, the input corresponding to the request to change the current selected environmental value for the setting. In some embodiments, in response to detecting the input corresponding to the request to change the current selected environmental value for the setting, the computer system displays, via the display generation component, second content (e.g., 804 in FIG. 8C) (e.g., of a second type different from the first type and/or corresponding to a second sensor value different from the first sensor value and/or a second type of sensor value different from the first type of sensor value) different from the first content in the third area of the user interface. In some embodiments, the second content was not previously displayed before detecting the input corresponding to the request to change the current selected environmental value for the setting. In some embodiments, the second content is a representation of the current selected environmental value for the setting, and the first content is a representation of the current detected environmental value for the setting. In some embodiments, the second content is a representation of the current detected environmental value for the setting, and the first content is a representation of the current selected environmental value for the setting. Displaying, via the display generation component, second content in response to detecting the input corresponding to the request to change the current selected environmental value for the setting enables the computer system to provide a user with information at second location that is not obstructed by a body part of the user, thereby providing improved visual feedback to the user and reducing the number of inputs needed to perform an operation.

In some embodiments, the input corresponding to the request to change the current selected environmental value for the setting is directed to an area outside of the third area. In some embodiments, in response to detecting an input directed to the third area, the computer system would not move display of the indication of the current selected environmental value. Displaying, via the display generation component, second content in an area outside of the third area in response to detecting the input corresponding to the request to change the current selected environmental value for the setting enables the computer system to provide a user with information at second location that is not obstructed by a body part of the user, thereby providing improved visual feedback to the user and reducing the number of inputs needed to perform an operation.

In some embodiments, the second content (e.g., 804 in FIG. 8C) (e.g., humidity value, calendar information, time of data information, and/or type of thermostat) includes information that is different (e.g., a different type and/or corresponding to a different set of one or more sensors) from the current selected environmental value (e.g., 890). Displaying second content that includes information that is different from a current selected environmental value enables the computer system to provide the user with a variety of relevant information to the user without the information being obstructed by a body part of the user, thereby providing improved visual feedback to the user and reducing the number of inputs needed to perform an operation.

In some embodiments, the user interface includes a representation of a control. In some embodiments, while displaying the user interface that includes the representation of the control (e.g., 806), the computer system detects, via the one or more input devices, a second input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to a first location (e.g., a first end of the representation of the control) on the representation of the control. In some embodiments, in response to detecting the second input directed to the first location of the representation of the control (e.g., 806), the computer system moves the indication of the current selected environmental value (e.g., 890) to a third position, wherein the third position corresponds to a first environmental value. In some embodiments, the amount moved by the current selected environmental value along the representation of the control corresponds to the number of inputs received at the first location. Moving the indication of the current selected environmental value to a third position in response to detecting the second input directed to the first location of the representation of the control provides the computer system change the indication of the current selected environmental value, thereby providing additional control options without cluttering the user interface.

In some embodiments, while displaying the user interface that includes the representation of the control (e.g., 806), the computer system detects, via the one or more input devices, a third input (e.g., one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction) directed to a second location on the representation of the control (e.g., 806), wherein the first location on the representation of the control is on a first side of the indication of the current selected value (e.g., 890) and the second location on the representation of the control is on a second side of the indication of the current selected value different from the first side. In some embodiments, in response to detecting the third input directed to the second location on the representation of the control (e.g., 806), the computer system moves the indication of the current selected environmental value (e.g., 890) to a fourth position different from the third position, wherein the fourth position corresponds to an environmental value that is less than an environmental value that corresponds to the third position. In some embodiments, the amount moved by the current selected environmental value along the representation of the control corresponds to the number of inputs received at the second location. Moving the indication of the current selected environmental value to a fourth position different from the third position in response to detecting the third input directed to the second location on the representation of the control enables the computer system to provide the user with a way to change the current selected environmental value, thereby providing additional control options without cluttering the user interface.

In some embodiments, in response to detecting the second input directed to the first location of the representation of the control (e.g., 806), the computer system provides haptic output. In some embodiments, in response to detecting the third input directed to the second location on the representation of the control, the computer system provides haptic output. Providing a haptic output in response to detecting the second input at the first location of the representation of the control enables the computer system to notify a user of a received input, thereby reducing the number of inputs needed to perform an operation and providing improved feedback to the user.

In some embodiments, another set of one or more indications (e.g., as compared to the first set of one or more indications and/or the second set of one or more indications) are not displayed in an area that is between the indication of the current selected environmental value for the setting (e.g., 890) and the indication of the current detected environmental value for the setting of the device (e.g., 802) while the first set of one or more indications (e.g., 814 in FIG. 8D) is displayed (and, in some embodiments, while the second set of one or more indications is displayed). Displaying the first set of one or more indications in an area between an indication of a current selected environmental value for a setting and an indication of the current environmental value for the setting of the device and not displaying another set of one or more indications between the area of the indication of the current selected environmental value for the setting and the indication of the current detected environmental value of the setting while displaying the first set of one more indications enables the computer system to notify the difference between the current temperature and the selected temperature, thereby providing improved visual feedback to the user and reducing the number of inputs needed to perform an operation.

In some embodiments, while displaying the user interface that includes the first set of one or more indications (e.g., 814 in FIG. 8D) at the first set of one or more positions between the indication of the current selected environmental value for the setting (e.g., 890) and the indication of the current detected environmental value for the setting of the device (e.g., 802), detecting a first change in the current detected environmental value for the setting of the device. In some embodiments, the first change in the current selected environmental value of the setting of the device is due to an automation to adjust the current selected environmental value based a trigger (e.g., time, event, and/or weather) set by the user. In some embodiments, in response to detecting the first change in the current detected environmental value for the setting of the device (e.g., 802), updating display of the first set of one or more indications (e.g., 814 in FIG. 8D) to a different number of indications. In some embodiments, in response to detecting the change in the current detected environmental value for the setting of the device and in accordance with a determination that the first change in the current detected environmental value for the setting of the device is a first respective change (e.g., value increases and/or becomes more intense), the computer system displays an indication as a part of the first set of one or more indications that was not previously displayed. In some embodiments, in response to detecting the change in the current detected environmental value for the setting of the device and in accordance with a determination that the first change in the current detected environmental value for the setting of the device is a second respective change (e.g., value decreases and/or becomes less intense) different from the first respective change, the computer system removes an indication from being displayed as a part of the first set of one or more indications that was not previously displayed. Updating display of the first set of one or more indications to a different number of indications in response to detecting the first change in the current detected environmental value for the setting of the device enables the computer system to automatically notify the user based on changes in the environment, thereby reducing the number of inputs needed to perform an operation, providing improved visual feedback, and performing an operation when a set of conditions have been met without requiring further user input.

In some embodiments, while displaying the user interface that includes the first set of one or more indications (e.g., 814 in FIG. 8D) at the first set of one or more positions between the indication of the current selected environmental value for the setting (e.g., 890) and the indication of the current detected environmental value for the setting of the device (e.g., 802), detecting a second change in the current detected environmental value for the setting of the device. In some embodiments, the second change in the current selected environmental value of the setting of the device is due to an automation to adjust the current selected environmental value based a trigger (e.g., time, event, and/or weather) set by the user, and in some embodiments, in response to detecting the second change in the current detected environmental value for the setting of the device (e.g., 802), moving display of the current selected environment value towards or away from a position corresponding to the current detected environmental value. In some embodiments, in response to detecting the second change in the current detected environmental value for the setting of the device and in accordance with a determination that the second change in the current detected environmental value for the setting of the device is the first respective change, the computer system moves display of the current selected environment value away from the position corresponding to the current detected environmental value. In some embodiments, and in accordance with a determination that the second change in the current detected environmental value for the setting of the device is the second respective change, the computer system moves display of the current selected environment value toward the position corresponding to the current detected environmental value. Moving display of the current selected environment value towards or away from a position corresponding to the current detected environmental value in response to detecting the second change in the current detected environmental value for the setting of the device enables the computer system to automatically notify the user based on changes in the environment, thereby reducing the number of inputs needed to perform an operation, providing improved visual feedback, and performing an operation when a set of conditions have been met without requiring further user input.

In some embodiments, after displaying the second set of one or more indications (e.g., 814 in FIG. 8F) at the second set of one or more positions between the indication of the current selected environmental value for the setting (e.g., 890) and the indication of the current detected environmental value for the setting of the device (e.g., 802), detecting a request for the computer system (e.g., 600) to transition to operate in a first respective mode. In some embodiments, detecting a request for the computer system to transition to operate in the first respective mode includes detecting one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction. In some embodiments, in response to detecting the request for the computer system to transition (e.g., from operating in a first mode) to operate in the first respective. In some embodiments, in accordance with a determination that the current detected environmental value (e.g., 802) is a second environmental value and the first respective mode is a third mode, displaying, via the display generation component, a fifth set of one or more indications between the indication of the current selected environmental value for the setting (e.g., 890) and the indication of the current detected environmental value for the setting of the device. In some embodiments, in accordance with a determination that the current detected environmental value (e.g., 802) is the second environmental value and the first respective mode is the fourth mode different from the third mode, forgoing displaying, via the display generation component, the fifth set of one or more indications between the indication of the current selected environmental value for the setting (e.g., 890) and the indication of the current detected environmental value for the setting of the device (e.g., 802). In some embodiments, the fourth mode is a heating mode, and the third mode is a cooling mode, or vice-versa. In some embodiments, in accordance with a determination that the current detected environmental value is another environmental value different from the second environmental value and the first respective mode is the third mode, the computer system does not display, via the display generation component, the fifth set of one or more indications between the indication of the current selected environmental value for the setting and the indication of the current detected environmental value for the setting of the device; In some embodiments, in accordance with a determination that the current detected environmental value is another environmental value different from the second environmental value and the respective mode is the fourth mode, the computer system displays, via the display generation component, the fifth set of one or more indications between the indication of the current selected environmental value for the setting and the indication of the current detected environmental value for the setting of the device. Displaying or not displaying the fifth set of one or more indications between the indication of the current selected environmental value for the setting and the indication of the current detected environmental value for the setting of the device based on a set of one or more criteria being met allows the computer system to update the user regarding work and/or an operation being performed by an external device, thereby reducing the number of inputs needed to perform an operation, providing improved visual feedback, and performing an operation when a set of conditions have been met without requiring further user input.

In some embodiments, after displaying the second set of one or more indications (e.g., 814 in FIG. 8F) at the second set of one or more positions between the indication of the current selected environmental value for the setting (e.g., 890) and the indication of the current detected environmental value for the setting of the device (e.g., 802), the computer system detects a request for the computer system (e.g., 600) to transition to operate in a second respective mode. In some embodiments, detecting a request for the computer system to transition to operate in a second respective mode includes detecting one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction. In some embodiments, in response to detecting the request for the computer system to transition to operate in the second respective mode and in accordance with a determination that the second respective mode is a fifth mode and the indication of the current selected environmental value (e.g., 890) is in a first direction relative to the indication of the current detected environmental value (e.g., 802), the computer system displays, via the display generation component, a sixth set of one or more indications between the indication of the current selected environmental value for the setting and the indication of the current detected environmental value for the setting of the device. In some embodiments, in accordance with a determination that the second respective mode is the fifth mode and the indication of the current selected environmental value (e.g., 890) is in a second direction relative to the indication of the current detected environmental value (e.g., 802), the computer system forgoes displaying, via the display generation component, the sixth set of one or more indications between the indication of the current selected environmental value for the setting and the indication of the current detected environmental value for the setting of the device, wherein the second direction relative to the indication of the current detected environmental value is different from the first direction relative to the indication of the current detected environmental value. In some embodiments, in accordance with a determination that the second respective mode is a sixth mode different from the fifth mode and the indication of the current selected environmental value (e.g., 890) is in the first direction relative to the indication of the current detected environmental value, the computer system forgoes displaying, via the display generation component, the sixth set of one or more indications between the indication of the current selected environmental value for the setting and the indication of the current detected environmental value (e.g., 802) for the setting of the device. In some embodiments, in accordance with a determination that the second respective mode is the sixth mode and the indication of the current selected environmental value (e.g., 890) is in the second direction relative to the indication of the current detected environmental value, the computer system displays, via the display generation component, the sixth set of one or more indications between the indication of the current selected environmental value for the setting and the indication of the current detected environmental value for the setting of the device. In some embodiments, the sixth mode is a heating mode, and the fifth mode is a cooling mode, or vice-versa.

In some embodiments, after displaying the second set of one or more indications (e.g., 814 in FIG. 8F) at the second set of one or more positions between the indication of the current selected environmental value for the setting (e.g., 890) and the indication of the current detected environmental value for the setting of the device (e.g., 802), the computer system detects a request for the computer system (e.g., 600) to transition to operate in a third respective mode (e.g., 808c). In some embodiments, detecting a request for the computer system to transition to operate in a third respective mode includes detecting one or more tap inputs and/or in some embodiments, one or more non-tap inputs, such as one or more air inputs (e.g., pointing air gestures, tapping air gestures, swiping air gestures, and/or moving hand gestures), gaze inputs, gaze-and-hold inputs, mouse clicks, mouse click-and-drags, voice commands, selection inputs, and/or inputs that move the computer system in a particular direction. In some embodiments, in response to detecting the request for the computer system to transition (e.g., from operating in a first mode) to operate in the third respective mode and in accordance with a determination that the third respective mode is a seventh mode, the computer system displays, via the display generation component, a seventh set of one or more indications on a first side of the indication of the current selected environmental value (e.g., 890) without displaying one or more indications on a second side of the indication of the current selected environmental value. In some embodiments, in accordance with a determination that the third respective mode is an eighth mode different from the seventh mode, the computer system displays, via the display generation component, an eighth set of one or more indications on the second side of the indication of the current selected environmental value (e.g., 890) without displaying one or more indications on the first side of the indication of the current selected environmental value. In some embodiments, the seventh mode is a heating mode and the eighth mode is a cooling mode, or vice-versa. Displaying a set of one or more indications on a particular side of the indication of the current selected environmental value without displaying another one or more indications on another side of the indication enables the computer system to automatically provide the user with feedback concerning the state of the external device performing one or more operations, thereby reducing the number of inputs needed to perform an operation, providing improved visual feedback to the user, and performing an operation when a set of conditions has been met without requiring further user input, and reducing the number of inputs needed to perform an operation.

In some embodiments, the user interface includes an indication of a terminal environmental value (e.g., 806) (e.g., minimum temperature, maximum temperature, minimum cooling temperature while the computer system is operating in a cooling mode, and/or maximum heating temperature while the computer system is operating in a heating mode) that corresponds to a terminal operating state of the device. In some embodiments, the indication of the terminal environmental value is displayed at a position on a scale that is not the position of the minimum and/or maximum value of the scale (e.g., 50 degrees is minimum cooling; however, the minimum value of the scale is 0 degrees; 35 degrees is minimum cooling; however, the minimum value of the scale is 10 degrees; 80 degrees is maximum heating; however, the maximum value of the scale is 100 degrees; and/or 90 degrees is maximum cooling; however, the maximum value of the scale is 120 degrees).

Note that details of the processes described above with respect to method 1000 (e.g., FIG. 10) are also applicable in an analogous manner to the methods described herein. For example, method 1000 optionally includes one or more of the characteristics of the various methods described above with reference to method 700. For example, one or more steps of method 700 of managing an appearance of output for an external device can utilized for displaying a control indicating work performed by an external device.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to provide one or more customizations of output that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver appearances of output that may be interesting to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of external device customization services, the present technology can be configured to allow users to select to “opt in” or “opt out” of participation in the collection of personal information data during registration for services or anytime thereafter. In another example, users can select not to provide external device data for external device customization services. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the external device customization services, or publicly available information.

What is claimed is:

1. A method, comprising:
at a computer system that is in communication with a display generation component and one or more input devices:
displaying, via the display generation component, a user interface that includes:
an indication of a current selected environmental value for a setting of a device;
an indication of a current detected environmental value for the setting of the device; and
a first set of one or more indications at a first set of one or more positions between the indication of the current selected environmental value for the setting and the indication of the current detected environmental value for the setting of the device;
while displaying the first set of one or more indications at the first set of one or more positions, detecting, via the one or more input devices, an input corresponding to a request to change the current selected environmental value for the setting; and
in response to detecting the input corresponding to the request to change the current selected environmental value for the setting:
moving display of the indication of the current selected environmental value from a first position to a second position; and
displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

2. The method of claim 1, wherein:
the first set of one or more indications at the first set of one or more positions is displayed in a first area of the user interface having a length that corresponds to a difference between the current selected environmental value at the first position and the current detected environmental value; and
the second set of one or more indications at the second set of one or more positions is displayed in a second area of the user interface having a length that corresponds to a difference between the current selected environmental value for the setting at the second position and the current detected environmental value.

3. The method of claim 1, wherein the current selected environmental value is a first temperature value, and the current detected environmental value is a second temperature value.

4. The method of claim 1, wherein the user interface includes a first content in a third area of the user interface, the method further comprising:
while displaying the user interface that includes the first content in the third area, detecting, via the one or more input devices, the input corresponding to the request to change the current selected environmental value for the setting; and
in response to detecting the input corresponding to the request to change the current selected environmental value for the setting, displaying, via the display generation component, second content different from the first content in the third area of the user interface.

5. The method of claim 4, wherein the input corresponding to the request to change the current selected environmental value for the setting is directed to an area outside of the third area.

6. The method of claim 5, wherein the second content includes information that is different from the current selected environmental value.

7. The method of claim 1, wherein the user interface includes a representation of a control, the method further comprising:
while displaying the user interface that includes the representation of the control, detecting, via the one or more input devices, a second input directed to a first location on the representation of the control; and
in response to detecting the second input directed to the first location of the representation of the control, moving the indication of the current selected environmental value to a third position, wherein the third position corresponds to a first environmental value.

8. The method of claim 7, further comprising:
while displaying the user interface that includes the representation of the control, detecting, via the one or more input devices, a third input directed to a second location on the representation of the control, wherein the first location on the representation of the control is on a first side of the indication of the current selected value and the second location on the representation of the control is on a second side of the indication of the current selected value different from the first side; and
in response to detecting the third input directed to the second location on the representation of the control, moving the indication of the current selected environmental value to a fourth position different from the third position, wherein the fourth position corresponds to an environmental value that is less than an environmental value that corresponds to the third position.

9. The method of claim 7, further comprising:
in response to detecting the second input directed to the first location of the representation of the control, providing haptic output.

10. The method of claim 1, wherein another set of one or more indications are not displayed in an area that is between the indication of the current selected environmental value for the setting and the indication of the current detected environmental value for the setting of the device while the first set of one or more indications is displayed.

11. The method of claim 1, wherein:
while displaying the user interface that includes the first set of one or more indications at the first set of one or more positions between the indication of the current selected environmental value for the setting and the indication of the current detected environmental value for the setting of the device, detecting a first change in the current detected environmental value for the setting of the device; and
in response to detecting the first change in the current detected environmental value for the setting of the device, updating display of the first set of one or more indications to a different number of indications.

12. The method of claim 1, wherein:
while displaying the user interface that includes the first set of one or more indications at the first set of one or more positions between the indication of the current selected environmental value for the setting and the indication of the current detected environmental value for the setting of the device, detecting a second change in the current detected environmental value for the setting of the device;
in response to detecting the second change in the current detected environmental value for the setting of the device, moving display of the current selected environment value towards or away from a position corresponding to the current detected environmental value.

13. The method of claim 1, wherein:
after displaying the second set of one or more indications at the second set of one or more positions between the indication of the current selected environmental value for the setting and the indication of the current detected environmental value for the setting of the device, detecting a request for the computer system to transition to operate in a first respective mode; and
in response to detecting the request for the computer system to transition to operate in the first respective mode:
in accordance with a determination that the current detected environmental value is a second environmental value and the first respective mode is a third mode, displaying, via the display generation component, a fifth set of one or more indications between the indication of the current selected environmental value for the setting and the indication of the current detected environmental value for the setting of the device; and
in accordance with a determination that the current detected environmental value is the second environmental value and the first respective mode is the fourth mode different from the third mode, forgoing displaying, via the display generation component, the fifth set of one or more indications between the indication of the current selected environmental value for the setting and the indication of the current detected environmental value for the setting of the device.

14. The method of claim 1, further comprising:
after displaying the second set of one or more indications at the second set of one or more positions between the indication of the current selected environmental value for the setting and the indication of the current detected environmental value for the setting of the device, detecting a request for the computer system to transition to operate in a second respective mode; and
in response to detecting the request for the computer system to transition to operate in the second respective mode:
in accordance with a determination that the second respective mode is a fifth mode and the indication of the current selected environmental value is in a first direction relative to the indication of the current detected environmental value, displaying, via the display generation component, a sixth set of one or more indications between the indication of the current selected environmental value for the setting and the indication of the current detected environmental value for the setting of the device;
in accordance with a determination that the second respective mode is the fifth mode and the indication of the current selected environmental value is in a second direction relative to the indication of the current detected environmental value, forgoing displaying, via the display generation component, the sixth set of one or more indications between the indication of the current selected environmental value for the setting and the indication of the current detected environmental value for the setting of the device, wherein the second direction relative to the indication of the current detected environmental value is different from the first direction relative to the indication of the current detected environmental value;
in accordance with a determination that the second respective mode is a sixth mode different from the fifth mode and the indication of the current selected environmental value is in the first direction relative to the indication of the current detected environmental value, forgoing displaying, via the display generation component, the sixth set of one or more indications between the indication of the current selected environmental value for the setting and the indication of the current detected environmental value for the setting of the device; and
in accordance with a determination that the second respective mode is the sixth mode and the indication of the current selected environmental value is in the second direction relative to the indication of the current detected environmental value, displaying, via the display generation component, the sixth set of one or more indications between the indication of the current selected environmental value for the setting and the indication of the current detected environmental value for the setting of the device.

15. The method of claim 1, further comprising:
after displaying the second set of one or more indications at the second set of one or more positions between the indication of the current selected environmental value for the setting and the indication of the current detected environmental value for the setting of the device, detecting a request for the computer system to transition to operate in a third respective mode; and
in response to detecting the request for the computer system to transition to operate in the third respective mode:
in accordance with a determination that the third respective mode is a seventh mode, displaying, via the display generation component, a seventh set of one or more indications on a first side of the indication of the current selected environmental value without displaying one or more indications on a second side of the indication of the current selected environmental value; and
in accordance with a determination that the third respective mode is an eighth mode different from the seventh mode, displaying, via the display generation component, an eighth set of one or more indications on the second side of the indication of the current selected environmental value without displaying one or more indications on the first side of the indication of the current selected environmental value.

16. The method of claim 1, wherein the user interface includes an indication of a terminal environmental value that corresponds to a terminal operating state of the device.

17. A non-transitory computer-readable storage medium storing one or more programs configured to be executed by one or more processors of a computer system that is in communication with a display generation component and one or more input devices, the one or more programs including instructions for:
displaying, via the display generation component, a user interface that includes:
an indication of a current selected environmental value for a setting of a device;
an indication of a current detected environmental value for the setting of the device; and
a first set of one or more indications at a first set of one or more positions between the indication of the current selected environmental value for the setting and the indication of the current detected environmental value for the setting of the device;
while displaying the first set of one or more indications at the first set of one or more positions, detecting, via the one or more input devices, an input corresponding to a request to change the current selected environmental value for the setting; and
in response to detecting the input corresponding to the request to change the current selected environmental value for the setting:
moving display of the indication of the current selected environmental value from a first position to a second position; and
displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.

18. A computer system that is in communication with a display generation component and one or more input devices, comprising:
one or more processors; and
memory storing one or more programs configured to be executed by the one or more processors, the one or more programs including instructions for:
displaying, via the display generation component, a user interface that includes:
an indication of a current selected environmental value for a setting of a device;
an indication of a current detected environmental value for the setting of the device; and
a first set of one or more indications at a first set of one or more positions between the indication of the current selected environmental value for the setting and the indication of the current detected environmental value for the setting of the device;
while displaying the first set of one or more indications at the first set of one or more positions, detecting, via the one or more input devices, an input corresponding to a request to change the current selected environmental value for the setting; and
in response to detecting the input corresponding to the request to change the current selected environmental value for the setting:
moving display of the indication of the current selected environmental value from a first position to a second position; and
displaying, via the display generation component, a second set of one or more indications at a second set of one or more positions between the indication of the current selected environmental value for the setting and the indication of the current detected environmental value for the setting of the device, wherein at least one indication in the second set of one or more indications was not previously displayed before the input directed to the indication of a current selected environmental value for the setting was detected.
